(19) United States
(12) Patent Application Publication
(10) Pub. No.: US 2020/0226535 A1
(43) Pub. Date: Jul. 16, 2020

(54) SMART PURCHASE AND DELIVERY OF CONSUMABLE ITEMS

(71) Applicant: Koji Yoden, Tamba (JP)

(72) Inventor: Koji Yoden, Tamba (JP)

(21) Appl. No.: 16/245,265

(22) Filed: Jan. 11, 2019

(51) Int. Cl. G06Q 10/08; H04W 84/04

(52) U.S. Cl. CPC G06Q 10/087; H04W 84/04; G06Q 10/083

(57) ABSTRACT

In some embodiments, a system may include a server that manages shipment of consumable items such as refills, replacement cartridges, disposable items, etc. The server may be under control of a seller of the consumable items. The system may further include a device associated with a consumable item. The device may be the consumable item itself that is a disposable product. Alternatively, the device may be a device in which a separate consumable item can be refilled, or a device which a separate consumable item can be attached to and detached or removed from. The system may further include a user's mobile communication device that can be in communication with at least one of the server and the device. The device associated with a consumable item may automatically issue a request associated with the consumable item to the server over network, upon determining that the consumable item has exhausted, finished up, worn out, or otherwise needs to be replaced with a new one. In response to the request, the server may automatically perform a shipment process for shipment of a new one of the consumable item.

### TECHNICAL FIELD

The present disclosure relates to smart distribution or delivery of a consumable item between a distributor and a user of such consumable item, using information technologies.

### BACKGROUND

Today, it's not too much to say that we live in a world of consumable items. We are surrounded by them and consume them in our daily lives. An example of such consumable items may include a device or instrument, part or the entire of which is consumed, worn, or exhausted by the user, such as a toothbrush that we regularly use to clean up the teeth by consuming bristles that are part of the toothbrush and that we replace with a new one when the bristles are consumed, worn, or exhausted. Another example of the consumable items may include an item contained in and dispensed out of a container for consumption by the user, such as detergent or cleaning agent contained in and dispensed out of a bottle to be used to wash dishes and so on. Another example of the consumable items may include an item consumed by a machine to perform a predetermined operation, such as toner used by a photocopier or a printer. Another example of the consumable items may be a food or beverage item to be eaten or drunk by consumers. The described examples are for the illustrative purpose only without any intention to limit the scope of consumable items described herein.

How sellers of such consumable items sell the items to the users and how users of the items purchase the items from the sellers are great concerns to them.

From the viewpoint of the users, every time they have consumed the consumable items, they generally need to dispose of the consumed items and purchase new ones for replacement. The purchase for replacement may be burdensome for the user since the purchase may typically involve time-consuming steps of: checking on a product name, product number, and/or other information for identifying the item the user should buy; and going out to a shop or store by car or something. Even for online shopping, the purchase may typically involve logging in an online store; selecting and ordering the identified item; and waiting for the ordered item to be delivered to the user's home. Besides, the user needs to perform such purchase in advance before the user has completely finished up the consumable items since it takes time, especially days for delivery when the item is purchased online, until the user gets a new consumable item in hand.

From the viewpoint of the sellers, constant purchases of the consumable items by the user from them may be the key to their business revenue. They typically spend a lot of money for advertisement and other campaigns to urge the fickle users to purchase a new one of the same consumable items and/or similar derivative items from them again. If the user has changed his/her mind to buy another branded consumable items from others, it may be damage to their constant revenue from the sales of the consumable items.

Therefore, the present disclosure addresses techniques, methods, and/or systems that may help improving user's constant purchases of consumable items and/or seller's constant deliveries of consumable items, using information technologies.

### SUMMARY

According to an aspect of the present invention, a system may include a server that manages shipment of consumable items such as refills, replacement cartridges, disposable items, etc. The server may be under control of a seller of the consumable items. The system may further include a device associated with a consumable item that is one of the consumable items managed by the server. The device may be the consumable item itself that is a disposable product. Alternatively, the device may be a device in which a separate consumable item can be refilled, or a device which a separate consumable item can be attached to and detached or removed from. The system may further include a user's mobile communication device that can be in communication with at least one of the server and the device.

According to an aspect of the present invention, the device associated with a consumable item may automatically issue a request associated with the consumable item to the server over network, upon determining that the consumable item has exhausted, finished up, worn out, or otherwise needs to be replaced with a new one. In response to the request, the server may automatically perform a shipment process for shipment of a new one of the consumable item.

According to an aspect of the present invention, consumable items are identified by respective item IDs that are managed in a database by the server. The device associated with a consumable item may automatically issue a request that includes an item ID assigned to the consumable item to the server over network, upon determining that the consumable has exhausted, finished up, worn out, or otherwise needs to be replaced with a new one. In response to the request, the server may automatically perform a shipment process for shipment of a new one of the consumable item identified by the item ID with reference to the database.

According to an aspect of the present invention, each consumable item belongs to a specific product category that is managed in a database by the server. The device associated with a consumable item may automatically issue a request that includes information indicative of the category to which the consumable item belongs to the server over network, upon determining that the consumable has exhausted, finished up, worn out, or otherwise needs to be replaced with a new one. In response to the request, the server may automatically present recommendation to a user by way of the user's mobile communication device as to one or more consumable items belonging to the category identified by the category information. The server may perform a shipment process for shipment of a consumable item selected by the user by way of the user's mobile communication device out of the recommended consumable items.

According to an aspect of the present invention, destination information is provided that indicates the final destination to which a consumable item should be directed when the consumable item is shipped to the user's address. The destination information may indicate the location at which the consumable item is situated in a house, office, building, etc. identified by the address. The device associated with the consumable item may automatically issue a request that includes the destination information to the server over network, upon determining that the consumable has exhausted, finished up, worn out, or otherwise needs to be replaced with a new one. The server may provide the destination information with a new one of the consumable item or its alternative item that is shipped to the user's address, so that the user is able to recognize what exhausted consumable item in the user's house, office, building, etc. the user should replace with the shipped new consumable item.

According to an aspect of the present invention, the request associated with the consumable item is issued and sent by the device directly to the server. According to another aspect, the request is issued by the device and forwarded by the user's mobile communication device to the server. According to yet another aspect, the user's mobile communication device issues the request on behalf of the device.

According to an aspect of the present invention, the destination information is a text description, graphical description, etc. of the location associated with the consumable item that is recognizable by the user and that may be displayed on a display of the user's mobile communication device. The destination information may be encoded on a label attached to the body, package, etc. of a shipped new consumable item, for example, in a form of a barcode readable by the user's mobile communication device.

According to an aspect of the present invention, the shipment process performed by the server includes generating and printing out an invoice and shipment label associated with the new consumable item to be shipped to the user's address. According to another aspect of the present invention, the shipment process includes generating and sending the item ID of the new consumable item to be shipped, to a terminal associated with a picking operator who works for the seller, instructing the operator to pick a corresponding item in an inventory for shipment.

According to an aspect of the present invention, the server regularly monitors whether or not the user is using a consumable item that has been shipped to the user's address by the seller according to the shipment process, namely, monitors if the user is continuously using an exhausted consumable item by, for example, refilling it him/herself or using a new consumable item which he/she purchased outside the seller instead of ordering a new consumable item to the seller. The seller may use the server to sanction or penalize the user when the user is found not to be using a consumable item shipped to the user's address according to the shipment process, by the server sending an instruction to the device to restrict use of the consumable item.

According to an aspect of the present invention, the device voluntarily monitors whether or not the device is in communication with the server. The device may voluntarily restrict use of a consumable item associated with the device upon determining that the device is not in communication with the server in order to prevent evasion from the above-mentioned server's monitoring and sanction by intentional disconnection from the server.

The present invention includes many other aspects of solution that improves user's constant purchases of consumable items and/or seller's constant deliveries of consumable items, using information technologies, which are described and illustrated in detail below.

### DRAWINGS

FIG. 1 illustrates an example of a system that may facilitate user's automatic ordering of consumable items and/or seller's constant deliveries of the consumable items, according to some embodiments.

FIG. 2A is a flowchart illustrating a process P1 for automatic ordering of a consumable item associated with a device in the system described in FIG. 1, according to some embodiments.

FIG. 2B is a flowchart illustrating a process P2 for automatic ordering of a consumable item associated with a device in the system described in FIG. 1, according to some embodiments.

FIG. 2C is a flowchart illustrating a process P3 for automatic ordering of a consumable item associated with a device in the system described in FIG. 1, according to some embodiments.

FIG. 3 illustrates a detailed system for automatic ordering of a consumable item associated with a device in the system described in FIG. 1, according to some embodiments.

FIG. 4A illustrates an example of a database DB1 that lists item IDs each of which is associated with a particular consumable item sellable by a seller, according to some embodiments.

FIG. 4B illustrates an example of a database DB1 in which consumable items are classified into categories with a multi-level hierarchy, according to some embodiments.

FIG. 4C illustrates an example of a database DB1 in which the database DB1 includes metadata other than basic information such as the brand and item name for each consumable item, according to some embodiments.

FIG. 5A is a flowchart illustrating an example of a typical discovery process P5, according to some embodiments.

FIG. 5B is a flowchart illustrating a process P6a for entering and storing a user ID, address, destination information associated with a consumable item on a server over a communication, according to some embodiments.

FIG. 5C is a flowchart illustrating a process P6b for entering and storing a user ID, address, destination information associated with a consumable item on a server over a communication, according to some embodiments.

FIG. 5D is a flowchart illustrating a process P6c for entering and storing a user ID, address, destination information associated with a consumable item on a server and a device associated with the consumable item over communications, according to some embodiments.

FIG. 6A illustrates an example of a tag, in which the tag is attached on the body of a device associated with a consumable item, according to some embodiments.

FIG. 6B illustrates another example of a tag, in which the tag is attached on a package box in which a device associated with a consumable item is packaged when the device is sold or shipped to the user, according to some embodiments.

FIG. 6C is a flowchart illustrating an example of a process P7a for a user's mobile communication device to retrieve data stored on a NFC or RFID tag, according to some embodiments.

FIG. 6D is a flowchart illustrating an example of a process P7b for a user's mobile communication device to retrieve data stored on a tag in a form of a barcode, according to some embodiments.

FIG. 7A is a flowchart illustrating an example of a step for determination as to necessity of ordering a consumable item in the process for automatic ordering of the consumable item, according to some embodiments.

FIG. 7B is a flowchart illustrating another example of a step for determination as to necessity of ordering a consumable item in the process for automatic ordering of the consumable item, according to some embodiments.

FIG. 8A is a flowchart illustrating an example of steps for issuance of an order for a consumable item and for processing the order in the process for automatic ordering of the consumable item, according to some embodiments.

FIG. 8B is a flowchart illustrating an example of steps for issuance of an order for a consumable item and processing the order using a user's mobile communication device in the process for automatic ordering of the consumable item, according to some embodiments.

FIG. 8C is a flowchart illustrating an example of detailed steps for prompting a user to identify a consumable item for shipment in the process for automatic ordering of the consumable item, according to some embodiments.

FIG. 8D is a flowchart illustrating another example of detailed steps for prompting a user to identify a consumable item for shipment in the process for automatic ordering of the consumable item, according to some embodiments.

FIG. 8E illustrates an example of a GUI through which to receive a user selection to identify a consumable item for shipment in the process for automatic ordering of the consumable item, according to some embodiments.

FIG. 8F illustrates another example of a GUI through which to receive a user selection to identify a consumable item for shipment in the process for automatic ordering of the consumable item, according to some embodiments.

FIG. 9A is a flowchart illustrating an example of steps for issuance of an order for a consumable item and for processing the order using a user's mobile communication device in the process for automatic ordering of the consumable item, according to some embodiments.

FIGS. 9B and 9C are flowcharts illustrating an example of detailed steps for prompting a user to identify a consumable item for shipment in the process for automatic ordering of the consumable item, according to some embodiments.

FIGS. 9D and 9E are flowcharts illustrating another example of detailed steps for prompting a user to identify a consumable item for shipment in the process for automatic ordering of the consumable item, according to some embodiments.

FIG. 10A is a flowchart illustrating an example of a step for determination as to necessity of ordering a consumable item in the process for automatic ordering of the consumable item, according to some embodiments.

FIG. 10B is a flowchart illustrating another example of a step for determination as to necessity of ordering a consumable item in the process for automatic ordering of the consumable item, according to some embodiments.

FIG. 10C is flowchart illustrating an example of detailed steps for issuance of an order for a consumable item and for processing the order using a user's mobile communication device in the process for automatic ordering of the consumable item, according to some embodiments.

FIGS. 11A, 11B, 11C, and 11D illustrate examples of a GUI for presentation of the destination of an ordered consumable item based on destination information, according to some embodiments.

FIG. 12A illustrates an example of management of one or more device IDs associated with a user ID on a server, according to some embodiments.

FIG. 12B illustrates an example of a shipment log on a server in which performed shipments are logged, according to some embodiments.

FIG. 13A is a flowchart illustrating an example of a process P10 for storing a record ID on a consumable item in the course of a shipment process, according to some embodiments.

FIG. 14A is a flowchart illustrating an example of a process P11 for monitoring a consumable item over a communication by a server to conditionally deactivate a device associated with the consumable item, according to some embodiments.

FIG. 14B illustrates an example of a record of measurement results accumulatively stored associated with a user ID and device ID by a server, according to some embodiments.

FIG. 14C illustrates an example of a record of measurement results accumulatively stored associated with a user ID, item ID, and destination information by a server, according to some embodiments.

FIG. 14D is a flowchart illustrating an example of a process P12 for monitoring a consumable item over a communication by a server to conditionally deactivate a device associated with the consumable item, according to some embodiments.

FIG. 14E is a flowchart illustrating an example of a process P13 for a voluntary examination or inspection of establishment of communication between a device associated with a consumable item and a server by the device, according to some embodiments.

FIG. 15A illustrates a system in which a server is in connection with a printer for performance of a shipment process.

FIG. 15B is a flowchart illustrating some steps for printing out an invoice and shipment label in a shipment process, according to some embodiments.

FIG. 15C illustrates an example of an invoice generated in a shipment process, according to some embodiments.

FIG. 15D illustrates an example of an invoice with destination information generated in a shipment process, according to some embodiments.

FIG. 15E illustrates another example of an invoice generated in a shipment process, according to some embodiments.

FIG. 16A illustrates a system in which a server is in connection with a seller's staff terminal for performance of a shipment process, according to some embodiments.

FIG. 16B is a flowchart illustrating some steps for providing a picking instruction on a seller's staff terminal in a shipment process, according to some embodiments.

FIG. 16C illustrates an example of a picking instruction displayed on a seller's staff terminal, according to some embodiments.

FIG. 17A is a block diagram illustrating an example of hardware and/or software components of a device associated with a consumable item, according to some embodiments where the device is the consumable item itself and thus the device itself may be ordered and purchased for replacement with a new one, according to some embodiments.

FIG. 17B is a block diagram illustrating an example of hardware and/or software components of a device associated with a consumable item, according to some embodiments where the consumable item is a refill for the device that is physically separate from the device, so that the consumable item may be independently ordered and purchased for replacement with a new one, according to some embodiments.

FIG. 17C is a block diagram illustrating another example of hardware and/or software components of a device associated with a consumable item, according to some embodiments where the consumable item is physically separate from the device and attachable to and detachable or removable from the device, so that the consumable item may be independently ordered and purchased for replacement with a new one, according to some embodiments.

FIG. 17D is a block diagram illustrating another example of hardware and/or software components of a device associated with a consumable item, according to some embodiments where the consumable item is physically separate from the device and attachable to and detachable or removable from the device, so that the consumable item may be independently ordered and purchased for replacement with a new one, according to some embodiments.

FIG. 17E is a block diagram illustrating another example of hardware and/or software components of a device associated with a consumable item, according to some embodiments where the consumable item is physically separate from the device and is designed to be stored or preserved in the device, so that the consumable item may be independently ordered and purchased for replacement with a new one, according to some embodiments.

FIG. 18 is a block diagram illustrating an example of hardware and/or software components of a server for shipment of a consumable item, according to some embodiments.

FIG. 19 is a block diagram illustrating an example of hardware and/or software components of a user's mobile communication device, according to some embodiments.

### DETAILED DESCRIPTION

Embodiments are described herein with reference to the attached drawings. Embodiments are only for the purpose of describing exemplary implementations of the inventive concept defined by Claims, and therefore are not intended to limit in any way the scope of the claimed invention.

### Overview of System

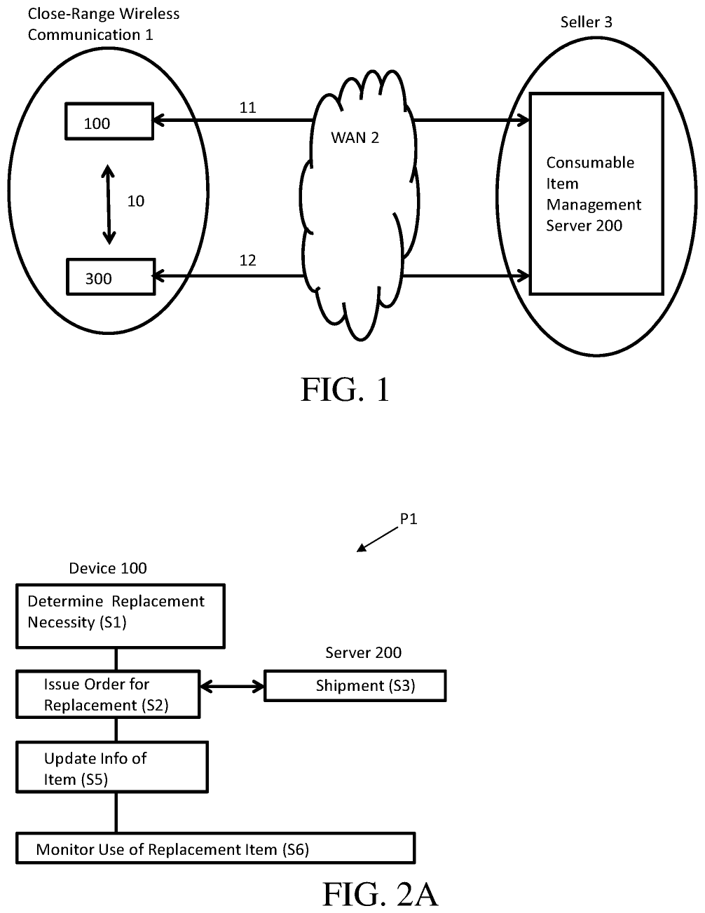

FIG. 1 illustrates a system that may help improving user's constant purchases of consumable items and/or seller's constant deliveries of consumable items, according to some embodiments. As depicted in FIG. 1, the system may include one or more devices 100 associated with a consumable item, a consumable item management server 200, and a user's mobile communication device 300. The device 100 may be a consumable item itself that includes at least one consumable component and that is usually disposed of and replaced with a new one in whole when the consumable item (device 100) has been finished up or expired. Examples of the consumable item of such type may include a toothbrush, shaver, lighting bulb, battery, etc. Alternatively, the device 100 may also be a device that is designed to use at least one replaceable consumable item in some manner. For example, the device 100 may be a device that has at least one consumable item as a replaceable part of the device 100, namely, a device in which the replaceable consumable item is housed or to which the consumable item is attached for the device 100 to consume the consumable item for operation. Or, the device 100 may be a device that has a compartment in which at least one consumable item is situated for storage or other purposes. In this type, the consumable item may be detached or removed from the device 100 and replaced with a new one when the consumable item has been finished up or otherwise should be replaced. Examples of the consumable item of such type may include a printer that uses toner or ink for printing operation with a toner or ink cartridge (consumable item) housed in the printer, a water dispenser that has a water cartridge (consumable item) attached in the dispenser for dispensing water inside the cartridge, a freezer that has a compartment in which food items (consumable items) is situated for storage, etc. The user's mobile communication device 300 may be a portable or handheld computing device capable of being in wireless communication with the device 100 and/or the server 200. The user's mobile communication device 300 may be a smartphone, tablet computer, personal computer (PC), or the like. The consumable item management server 200 is a server computer for management of ordering and shipment of consumable items. Details on the device 100, the mobile user's communication device 300, and the server 200 will be described later.

The device 100 and the user's mobile communication device 300 may establish a close-range wireless communication 10 with one another over a close-range wireless communication network 1 such as a wireless local area network (WLAN) and a wireless personal area network (WPAN). The WLAN, also referred to as Wi-FI, may be one that is pursuant to IEEE 802.11 specifications. In the WLAN communication, the devices 100 and 300 may communicate with one another via an access point or wireless router that provides the WLAN, in which case the device 100 is in wireless or wired connection to the router while the device 300 is in wireless connection to the router. Alternatively, the devices 100 and 300 may directly communicate with one another in a peer-to-peer (P2P) manner, in which case one of the devices 100 and 300 acts as the access point. The WPAN may be one that is pursuant to Bluetooth (trademark), ZigBee, Ultra-wideband (UWB), or others pursuant to IEEE 802.15 specifications. An example of the close-range wireless communication 10 also includes a very short-range communication, known as a Near-Field Communication (NFC) or a Radio Frequency Identification (RFID) communication, established by one of the devices 100 and 300 acting as a transmitter to broadcast signals and the other acting as a receiver to respond to the broadcasted signals. An example of the close-range wireless communication 10 also includes an infrared communication.

The device 100 and the consumable item management server 200 may establish a wide area network (WAN) communication 11, such as an Internet communication, with one another over a WAN 2 such as the Internet. The WAN communication 11 may be established via a LAN, in which case the device 100 is in wireless or wired connection to a router that is connected to the WAN 2. The WAN communication 11 may be established via a wireless cellular network including base stations each of which provides a wireless coverage area, such as a WiMAX or other metropolitan area network (MAN) pursuant to IEEE 802.16 specifications and 4G network or other mobile broadband network pursuant to specifications issued by International Telecommunication Union (ITU), in which case the cellular network is connected to the WAN 2.

The user's mobile communication device 300 and the consumable item management server 200 may also establish a WAN communication 12, such as an Internet communication, with one another over a WAN 2 such as the Internet. The WAN communication 12 may be established via a LAN, in which case the user's mobile communication device 300 is in wireless connection to a router that is connected to the WAN 2. The WAN communication 12 may be established via a wireless cellular network including base stations each of which provides a wireless coverage area, such as a WiMAX or other MAN pursuant to IEEE 802.16 specifications and 4G network or other mobile broadband network pursuant to specifications issued by International Telecommunication Union (ITU), in which case the cellular network is connected to the WAN 2.

The consumable item management server 200 may typically be operated under control of a seller 3 of one or more consumable items, residing in a seller's facility. An example of the seller 3 may include the manufacturer of the consumable items; a distributor or sales rep agreed with the manufacturer to sell the consumable items; and an online retailer that provides online shopping of the consumable items. The seller 3 may typically do business by receiving an order for a consumable item from a buyer (user), identifying the ordered consumable item in an inventory, and shipping the ordered consumable item to the address of the buyer (i.e., buyer's facility) using a delivery service. The server 200 may be implemented by a single computer or multiple computers networked together.

The device 100 is associated with a consumable item which is purchasable from the seller 3 via an online shopping through transaction using the consumable item management server 200 and which may be purchasable at retail stores in town as well. The device 100 may be such consumable item itself, in which case the device 100 itself may be ordered and purchased. The device 100 may also be a device configured to accommodate and consume such consumable item in operation, in which case such consumable item may be ordered and purchased, separately or independently from the device 100. The consumable item 100 may be a device, a tool, an apparatus, an appliance, an instrument, a piece of equipment, etc. which is fixed or installed in a non-mobile manner at a particular location in a user's facility such as the user's house and office. The consumable item 100 may also be a device, a tool, an apparatus, an appliance, an instrument, a piece of equipment, etc. which is designed to be carried and used by the user in a mobile manner inside or outside the user's facility. An example of the user's facility may include a user's home or house, office, and any other facility such as a hotel, factory, hospital, school, building, museum, theater, prison, and so on.

### Overview of Automatic Ordering

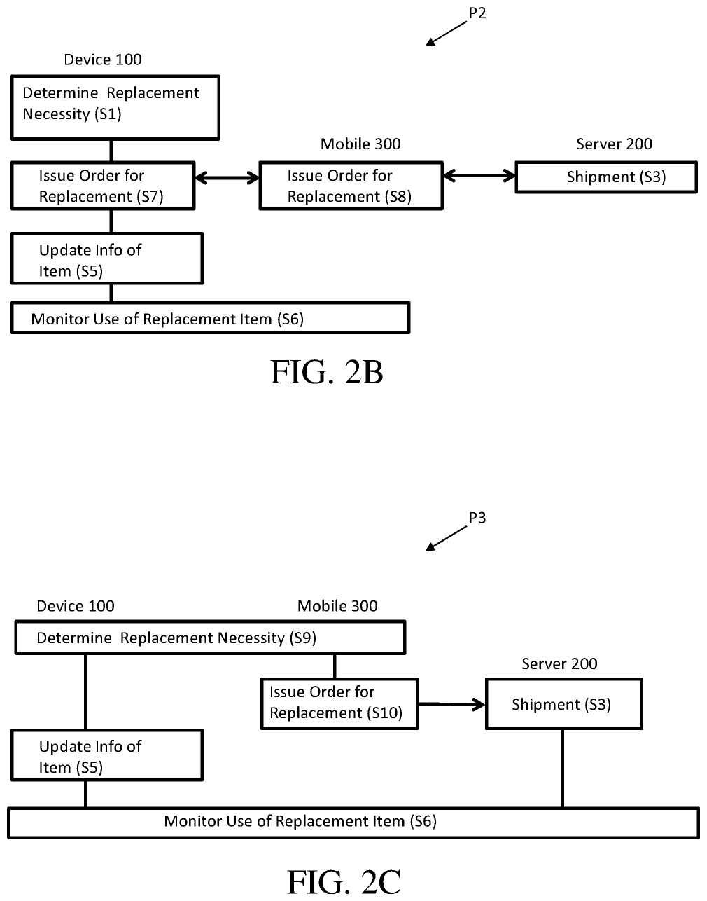

FIG. 2A is a flowchart illustrating an example of a process P1 for autonomous ordering of a consumable item associated with the device 100, according to some embodiments. The device 100 may autonomously determine whether a consumable item associated with the device 100 has been exhausted, finished up, worn out, or otherwise needs to be replaced with a new one (S1). Upon determining affirmatively that the consumable item needs to be replaced with a new one, the device 100 may autonomously issue a shipment request or order associated with the consumable item, and address the request to the server 200 over the communication 11 (S2). In response to the request, the server 200 may automatically perform a shipment process to ship a consumable item (S3). After issuance of the order (S2), the device 100 may update information associated with the consumable item associated with the device 100 (S5). The device 100 and server 200 in collaboration may monitor use of the consumable item shipped by the server 200 (S6).

FIG. 2B is a flowchart illustrating an example of a process P2 for autonomous ordering of a consumable item associated with the device 100, according to some embodiments. The device 100 may autonomously determine whether a consumable item associated with the device 100 has been exhausted, finished up, worn out, or otherwise needs to be replaced with a new one (S1). Upon determining affirmatively that the consumable item needs to be replaced with a new one, the device 100 may autonomously issue a shipment request or order (first shipment request) associated with the consumable item, and address the request to the user's mobile communication device 300 over the communication 10 (S7). The user's mobile communication device 100 may then issue a shipment request or order (second shipment request) associated with the consumable item based on the first request, and address the request to the server 200 over the communication 12 (S8). In response to the request, the server 200 may automatically perform a shipment process to ship a consumable item (S3). After issuance of the order (S7), the device 100 may update information associated with the consumable item associated with the device 100 (S5). The device 100 and server 200 in collaboration may monitor use of the consumable item shipped by the server 200 (S6).

FIG. 2C is a flowchart illustrating an example of a process P3 for autonomous ordering of a consumable item associated with the device 100, according to some embodiments. The device 100 and user's mobile communication device 300 in collaboration may autonomously determine whether a consumable item associated with the device 100 has been exhausted, finished up, worn out, or otherwise needs to be replaced with a new one (S9). Upon determining affirmatively that the consumable item needs to be replaced with a new one, the user's mobile communication device 300 may autonomously issue a shipment request or order associated with the consumable item, and address the request to the server 200 over the communication 12 (S10). In response to the request, the server 200 may automatically perform a shipment process to ship a consumable item (S3). After issuance of the order (S10), the device 100 may update information associated with the consumable item associated with the device 100 (S5). The device 100 and server 200 in collaboration may monitor use of the consumable item shipped by the server 200 (S6).

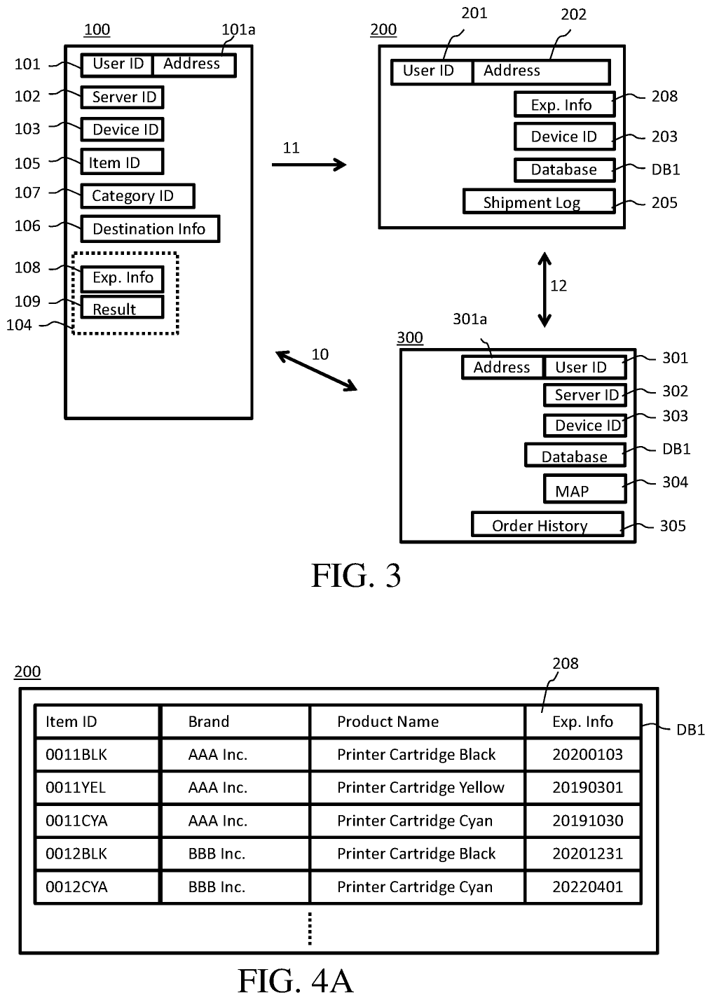

FIG. 3 illustrates a detailed system for automatic ordering of the consumable item associated with the device 100 according to the process P1, P2, or P3, according to the embodiments.

### Sever 200

The server 200 may have access to one or more user IDs 201 each of which uniquely identifies a particular user who is allowed to order his/her consumable item to the server 200. A discrete or individual user ID may be assigned to each user by the server 200.

The server 200 may also have access to one or more addresses 202 each of which is associated with a particular user ID 201. At least one address is associated with each user ID 201. The address 202 indicates a physical location such as a house and office of a corresponding user. The user ID 201 and address 202 may be stored as a form of a database in the server 200.

The server 200 may also have access to expiration information 208 indicative of expiration of a new one of the consumable item that is in stock under control of the seller 3 and will be shipped to the user of the device 100 as per request by the device 100.

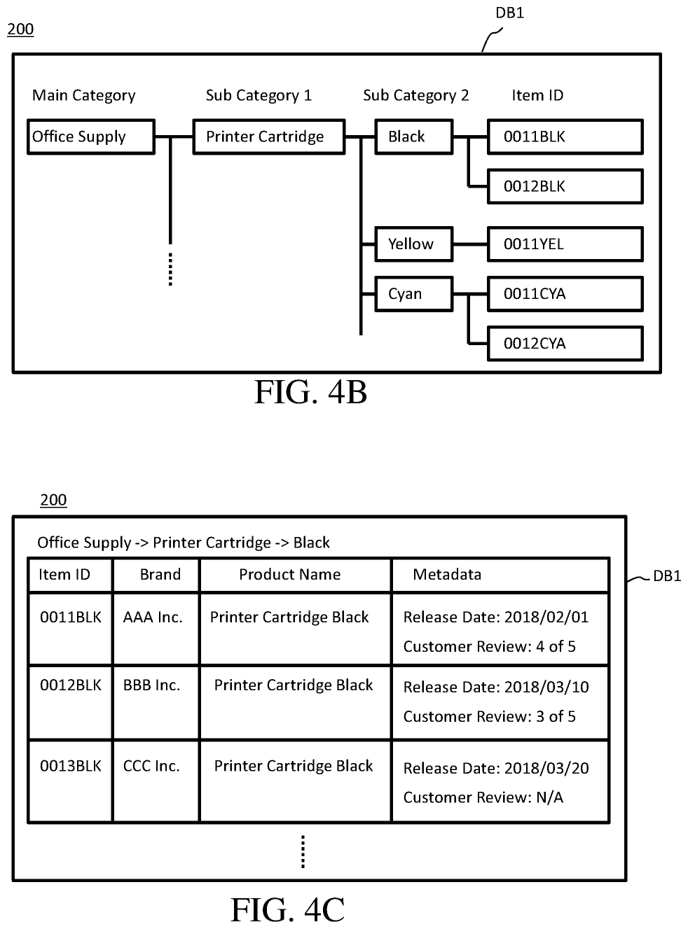

The server 200 may also have access to a database DB1 for management of a variety of consumable items by identifying each item using item IDs each of which is uniquely associated with a specific consumable item. FIG. 4A schematically illustrates an example of a database DB1 that lists item IDs each of which is associated with a particular consumable item that is sellable by the seller 3. Each consumable item may also be assigned the expiration information 208 indicative of the expiration date until which the corresponding consumable item is designed or made to be usable in a good condition. In an example illustrated in FIG. 4A, the database DB1 lists item IDs for a variety of printer cartridges (e.g., ink cartridges for an inkjet printer or toner cartridges for a laser printer) as consumable items, in which each item ID identifies the brand (e.g., manufacturer name) and the product name of a corresponding specific printer cartridge. In the example, the item ID “0011BLK” identifies a “Printer Cartridge Black” branded by “AAA Inc.”; the item ID “0011YEL” identifies a “Printer Cartridge Yellow” branded by “AAA Inc.”; the item ID “0011CYA” identifies a “Printer Cartridge Cyan” branded by “AAA Inc.”; the item ID “0012BLK” identifies a “Printer Cartridge Black” branded by “BBB Inc.”; and the item ID “0012CYA” identifies a “Printer Cartridge Cyan” branded by “BBB Inc.”. The item ID may be the identification that uniquely identifies a product model of a corresponding consumable item. The item ID may be pursuant to European Article Number (EAN), Japanese Article Number (JAN), Universal Product Code (UPC), International Standard Book Number (ISBN), Amazon Standard Identification Number (ASIN), or other identification standard. In the example illustrated in FIG. 4A, the item identified by “0011BLK” is assigned the expiration information 208 indicative of the date “Jan. 3, 2020”; the item identified by “0011YEL” is assigned the expiration information 208 indicative of the date “Mar. 1, 2019”; the item identified by “0011CYA” is assigned the expiration information 208 indicative of the date “Oct. 30, 2019”; the item identified by “0012BLK” is assigned the expiration information 208 indicative of the date “Dec. 31, 2020”; and the item identified by “0012CYA” is assigned the expiration information 208 indicative of the date “Apr. 1, 2022”. Furthermore, the server 200 may manage such variety of consumable items by category in the database DB1. In the embodiments, each consumable item may be categorized or classified into at least one category. There may be a hierarchy of categorization in which multiple categories are arranged in a graded order, in which case a single category may be further categorized into one or more low-level sub categories for detailed classification of items. FIG. 4B schematically illustrates an example of the database DB1 in which consumable items are classified into categories with a three-level hierarchy: main categories at the top of the hierarchy; first sub categories each of which is defined under a specific one of the main categories; and second sub categories each of which is defined under a specific one of the first sub categories. In the example illustrated in FIG. 4B, at least one first sub category “Printer Cartridge” is defined under a main category “Office Supply”, and at least three of second sub categories “Black”, “Yellow”, and “Cyan” are defined under the first sub category “Printer Cartridge”. In the example, the item IDs “0011BLK” and “0012BLK” belong to “Office Supply>Printer Cartridge”>“Black”; the item ID “0011YEL” belongs to “Office Supply>Printer Cartridge”>“Yellow”; and the item IDs “0011CYA” and “0012CYA” belong to “Office Supply>Printer Cartridge”>“Cyan”. The database DB1 in the embodiments may be referenced to identify items which belong to the same category. FIG. 4C schematically illustrates an example of the database DB1 in which the database DB1 includes metadata other than the basic information such as the brand and item name for each consumable item. A specific piece of metadata may be associated with a corresponding item ID to provide additional information for the corresponding consumable item. An example of the metadata may include the date of release and at least one user's review, for the corresponding consumable item. In the example illustrated in FIG. 4C, the item identified by the item ID 0011BLK is associated with metadata indicative of that its release date is Feb. 1, 2018, and 4-star average user's review is awarded to the item; the item identified by the item ID 0012BLK is associated with metadata indicative of that its release date is Mar. 10, 2018, and 3-star average user's review is awarded to the item; and the item identified by the item ID 0013BLK is associated with metadata indicative of that its release date is Mar. 20, 2018, and there is no user's review for the item yet.

The server 200 may also have access to one or more device IDs 203 each of which is associated with a particular user ID 201. Each device ID 203 identifies the user's mobile communication device 300 of a user. Each device ID 203 identifies a corresponding user's mobile communication device 300 as a destination of data transmission over the communication 12, so that the server 200 may transmit data to the user's mobile communication device 300 over the communication 12 by addressing the data to the device ID 203. An example of the device ID 203 may include the Internet Protocol (IP) address allocated to the user's mobile communication device 300.

The server 200 may further have access to a shipment log 205. The shipment log 205 may be a log or history that indicates, presents, or lists each shipment process performed by the server 200 at the step S3 for each user identified by a corresponding user ID 201. The server 200 may add, input, or generate a record of a shipment process in the shipment log 205 every time the server 200 performs the shipment process. Each record may include detailed information that identifies a corresponding shipment.

### Device 100

The device 100 may have access to a user ID 101 that identifies a user of the device 100. The user ID 101 may be presented or described in the format defined to present or describe the user IDs 201 in the server 200 so that the server 200 can identify or recognize the user ID 101. The user ID 101 may correspond to one of the user IDs 201 stored in the server 200.

The device 100 may also have access to an address 101a associated with the user of the device 100, namely, the user ID 101. The address 101a indicates the physical address of the user identified by the user ID 101, just as the address 202 in the server 200 does. The address 101a may be associated with the user ID 101 as a form of a database.

The device 100 may also have access to a server ID 102 that identifies the server 200 as a destination of data transmission over the communication 11, so that the device 100 may transmit data to the server 200 over the communication 11 by addressing the data to the server ID 102. An example of the server ID 102 may include the Internet Protocol (IP) address allocated to the server 200.

The device 100 may also have access to a device ID 103. The device ID 103 identifies the user's mobile communication device 300 paired with the device 100 as a destination of data transmission over the communication 10, so that the device 100 may send data to the user's mobile communication device 300 over the communication 10 by addressing the data to the device ID 103. An example of the device ID 103 may include the IP address allocated to the user's mobile communication device 300.

The device 100 may also have access to an item ID 105. The item ID 105 may be the identification uniquely identifying the consumable item associated with the device 100, which corresponds to one of the item IDs listed in the database DB1 in the server 200.

The device 100 may also have access to a category ID 107. The category ID 107 may be the identification uniquely identifying a category to which the consumable item associated with the device 100 belongs, which corresponds to one of the categories listed in the database DB1 in the server 200. The category ID 107 may be simply a text description of a category listed in the database DB1.

The device 100 may also have access to destination information 106 indicative of the destination of a new one of the consumable item. The destination information 106 may be indicative of where the consumable item is located in a user's place. The concept for the destination information 106 is as follows. In some situations, there are used many consumable items of the same model (i.e., consumable items identified by the same item ID) and/or of the same category in a location (e.g., building, office, factory, house, etc.) identified by the address 202. In the cases, when a new one of a consumable item has been shipped to and arrives at the location as a result of the shipment process at the step S3, the user may be at a loss as to which of the consumable items in the location the arrived item should be replaced with. For example, an office with a plurality of rooms may have a large number of replaceable lighting devices (e.g., fluorescent lights, light bulbs, etc.) of the same model being arranged over the rooms, in which case the user (e.g., an office manager or person in charge of office supplies) may be unable to recognize where in the office is a burned-out lighting device (as the consumable item) the user should replace with a new lighting device that has arrived at the office. In another example, a house may have a lot of non-rechargeable dry cells of the same category (e.g., AAA dry cell battery, AA dry cell battery, etc.) used in electronic gadgets such as a toy, remote, flashing light, etc. in the house, in which case the user may be unable to recognize in what gadget there is a consumed dry cell battery (as the consumable item) the user should replace with a new dry cell battery that has arrived at the house. Therefore, there may be demand for means for knowing or identifying which of the consumable items in the location should be replaced with a new consumable item that has been shipped to the location, i.e., where is the consumed consumable item in the location the new consumable item should be replaced with. To address the potential demand, in some embodiments, information indicative of the “destination” to which a new one of the consumable item should be directed (i.e., the place or location to which the consumable item belongs) may be provided and used in the shipment process. In an aspect where the device 100 is the consumable item itself which is thus replaced with a new one of the consumable item in whole, the destination information may be one indicative of a detailed place at which the device 100 (consumable item) resides. In another aspect where the device 100 is a device which has the consumable item as part thereof, the destination information may be one indicative of a detailed place at which the device 100 resides, or an identification of the device 100 unique to the device 100 that indicates to what device 100 among devices 100 the consumable item belongs.

The device 100 may also have access to expiration information 108 indicative of expiration of the consumable item associated with the device 100. An example of the expiration information 108 may be one indicative of a day, week, month, year, etc. such as an expiration date and best-before date until which the consumable item is designed or made to be usable in a good condition. The expiration information 108 may be preliminarily stored on the device 100 in the course of manufacture or sale of the device 100 or on the consumable item in the course of manufacture or sale of the consumable item.

The device 100 may also have access to a determination result 109 indicative of the result of determination at the step S1. The determination result 109 may be represented by a bit, wherein the bit “1” may indicate that the consumable item should be replaced with a new one, whereas the bit “0” may indicate that the consumable item does not need to be replaced with a new one. The determination result 109 with the bit “0” may be set by default, and the bit may be changed into “1” upon determination that the consumable item should be replaced at the step S1.

### Mobile 300

The user's mobile communication device 300 may have access to a user ID 301 that identifies a user of the device 100. The user ID 301 may be presented or described in the format defined to present or describe the user IDs 201 in the server 200 so that the server 200 can identify or recognize the user ID 301. The user ID 301 may correspond to one of the user IDs 201 stored in the server 200 and the user ID 101 stored on the device 100.

The user's mobile communication device 300 may also have access to an address 301a associated with the user of the device 100, namely, the user ID 301. The address 301a indicates the physical address of the user identified by the user ID 301, just as the address 202 in the server 200 does. The address 301a may be associated with the user ID 301 as a form of a database.

The user's mobile communication device 300 may also have access to a server ID 302. The server ID 302 identifies the server 200 as a destination of data transmission over the communication 12, so that the user's mobile communication device 300 may transmit data to the server 200 over the communication 12 by addressing the data to the server ID 302. An example of the server ID 302 may include the IP address allocated to the server 200.

The user's mobile communication device 300 may also have access to a device ID 303. The device ID 303 identifies the device 100 paired with the device 300 as a destination of data transmission over the communication 10, so that the user's mobile communication device 300 may send data to the device 100 over the communication 10 by addressing the data to the device ID 303. An example of the device ID 303 may include the IP address allocated to the device 100.

The user's mobile communication device 300 may also have access to the database DB1 as may be accessible by the server 200, as discussed above.

The user's mobile communication device 300 may also have access to a map 304. The map 304 may be an image graphically representing a location associated with the user ID 301, i.e., the location identified by one of the addresses 202 associated with one of the user IDs 201 which matches the user ID 301. The map 304 may be stored as a form of a computer file in a bitmap or another encoded format.

The user's mobile communication device 300 may also have access to an order history 305 indicative of an order which has been acknowledged by the user's mobile communication device 300 and processed at the step S3.

### Device ID

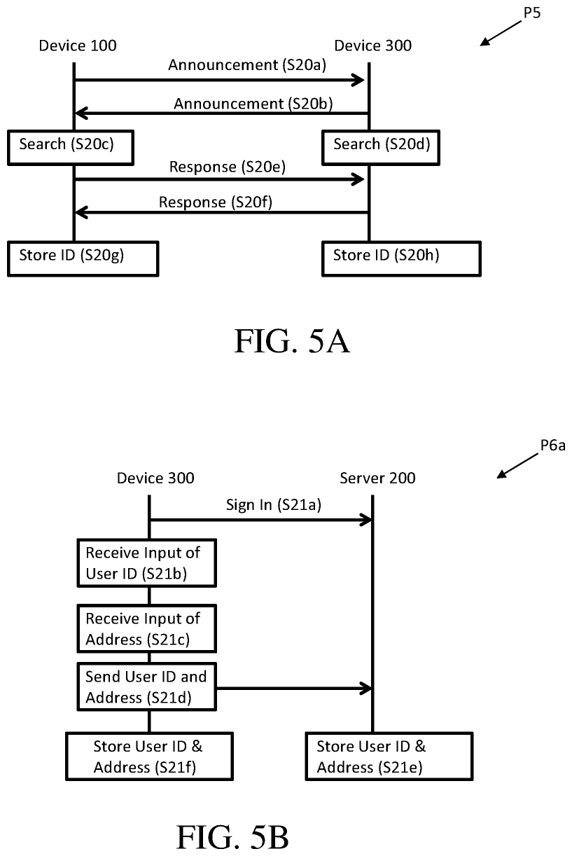

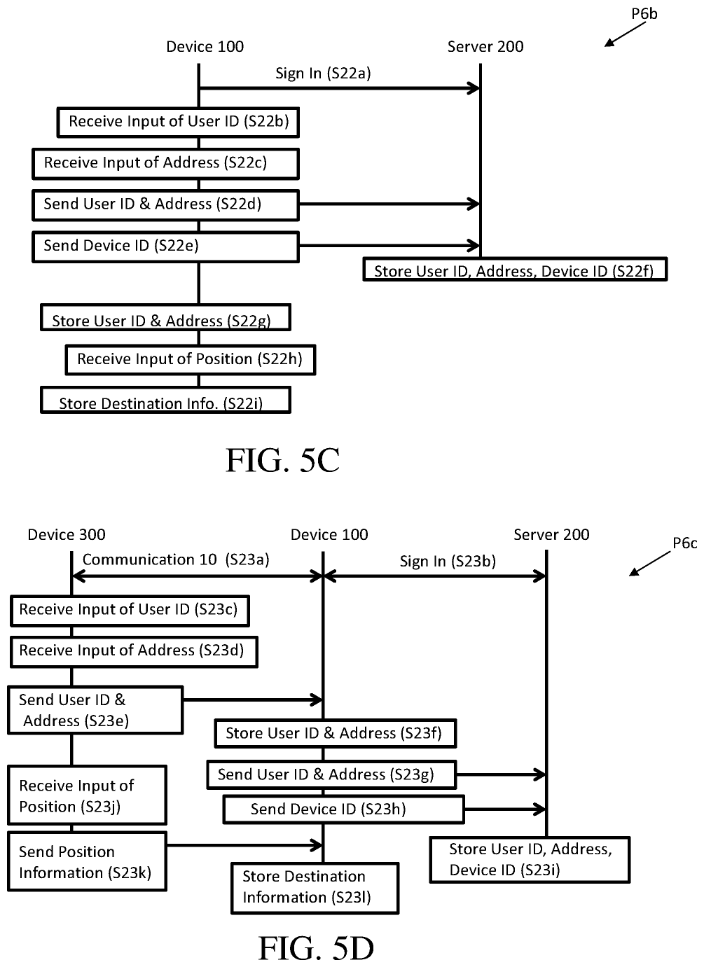

In some embodiments, the device 100 and the user's mobile communication device 300 may mutually exchange device IDs uniquely identifying the respective devices over the communication 10 to pair with one another. In an aspect where the communication 10 is established in accordance with a known service discovery process, the device IDs may be exchanged by way of the discovery process. The known service discovery process may include: Web Service Dynamic Discovery (WSD) approved by Organization for the Advancement of Structured Information Standards (OASIS), Domain Name System (DNS)-based Service Discovery (DNS-SD) such as multicast DNS (mDNS) published as RFC 6762, Simple Service Discovery Protocol (SSDP) used in Universal Plug And Play (UPnP), Service Discovery Protocol (SDP) used in Bluetooth, and the likes. FIG. 5A is a flowchart illustrating an example of a typical discovery process P5. As depicted herein, a typical known discovery process may include: announcement, advertisement, or notification of the presence by the device 100 and/or the user's mobile communication device 300 using a multicast message (S20a, S20b); search for devices of interest by the device 100 and/or the device 300 using a multicast message (S20c, S20d), and response to the search by the device 100 and/or the device 300 using a unicast message (S20e, S20f). The discovery process may enable the device 100 and the device 300 to know the presence of one another and mutually exchange the identifications (device IDs), such as MAC addresses, IP addresses, Bluetooth Device (BD) addresses, and Unique Identifiers (UID), and uniquely assigned names, for identification of the devices on the wireless communication 10. As depicted in FIG. 5A, the discovery process may finish by the device 100 and/or the device 300 storing the exchanged device IDs on a memory of the respective devices (S20g, S20h). In particular, the device 100 may store therein the received device ID identifying the device 300 as the device ID 103, whereas the user's mobile communication device 300 may store therein the received device ID identifying the device 100 as the device ID 303. The paring of the devices 100 and 300 may be accomplished according to the process P5.

### User ID, Address, Server ID, Item ID, Category ID, Destination Information, Expiration Information Stored by Default

In some embodiments, the user ID 101, address 101a, server ID 102, item ID 105, category ID 107, destination information 106, and/or expiration information 108 may be stored on the device 100 by default when the device 100 is sold in the market, in which case the user ID 101, address 101a, server ID 102, item ID 105, category ID 107, destination information 106, and/or expiration information 108 may be written on a memory of the device 100 by the seller 3. In an example where the seller 3 is involved in manufacture of the device 100, the user ID 101, address 101a, server ID 102, item ID 105, category ID 107, destination information 106, and/or expiration information 108 may be written on the device 100 in the process of manufacturing the device 100 in a factory. In another example, the user ID 101, address 101a, server ID 102, item ID 105, category ID 107, destination information 106, and/or expiration information 108 may be written on the device 100 after it's manufactured and before it's bought and shipped to the user, e.g., at a given time during the device 100 being under management of the seller 3 as inventory, in which case the user ID 101, address 101a, server ID 102, item ID 105, category ID 107, destination information 106, and/or expiration information 108 may be written on the device 100, for example, by an operator associated with the seller 3 in a warehouse upon reception of a purchase order for the device 100.

In some embodiments where the consumable item is attachable to and detachable or removable from the device 100, the user ID 101, address 101a, server ID 102, item ID 105, category ID 107, destination information 106, and/or expiration information 108 may be stored on the consumable item by default when the consumable item is sold in the market. The user ID 101, address 101a, server ID 102, item ID 105, category ID 107, destination information 106, and/or expiration information 108 may be written on a memory of the consumable item by the seller 3. In an example where the seller 3 is involved in manufacture of the consumable item, the user ID 101, address 101a, server ID 102, item ID 105, category ID 107, destination information 106, and/or expiration information 108 may be written on the consumable item in the process of manufacturing the consumable item in a factory. In another example, the user ID 101, address 101a, server ID 102, item ID 105, category ID 107, destination information 106, and/or expiration information 108 may be written on the consumable item after it's manufactured and before it's bought and shipped to the user, e.g., at a given time during the consumable item being under management of the seller 3 as inventory, in which case the user ID 101, address 101a, server ID 102, item ID 105, category ID 107, destination information 106, and/or expiration information 108 may be written on the consumable item, for example, by an operator associated with the seller 3 in a warehouse upon reception of a purchase order for the consumable item.

### Transmission of User ID, Address, Destination Information

In some embodiments, the user ID 201 and the associated addresses 202 may be entered and stored on the server 200 over the communication 12. In the embodiments, the user can sign in to the server 200 from his/her mobile communication device 300 to register his/her user ID and shipment address via the device 300. FIG. 5B is a flowchart illustrating a process P6a for entering and storing the user ID 201 on the server 200 over the communication 12. According to the process P6a, the user's mobile communication device 300 may initiate communication with the server 200 over the communication 12 for sign-in to the server 200 (S21a). For example, the user's mobile communication device 300 may use a browser to receive a user input of manually entering the URI of a web page for sign-in to the server 200 or use an app preliminarily associated with the URI, to load the sign-in page on the device 300. The user's mobile communication device 300 may receive a user input of manually entering the user ID on the sing-in page using an input device of the device 300 (S21b). The user's mobile communication device 300 may also receive a user input of manually entering the address on the sing-in page using the input device of the device 300 (S21c). The user's mobile communication device 300 may send the inputted user ID and the address to the server 200 over the communication 12 (S21d). The transmission of the user ID and address at the step S21d may include sending the user ID and address in response to the user's manual input of the user ID and address. The server 200 may then respond to the received user ID and address by associating the user ID and address on a storage device of the server 200 (S21e), whereby the server 200 may store the user ID 201 and the associated address 202. At the step S21e, the server 200 may store the user ID 201 and the address 202 associated with one another as a form of a database. The user's mobile communication device 300 may also locally store therein the inputted user ID and address as the user ID 301 and address 301a (S21f). The storage at the step S21f may include storing the user ID and address in response to the user's manual input of the user ID and address. At the step S21f, the device 300 may store the user ID 301 and the address 301a associated with one another as a form of a database.

In some embodiments, the user ID 201 and the associated address 202 may be entered and stored on the server 200 over the communication 11. In the embodiments, the user can sign in to the server 200 from the device 100 to register his/her user ID and shipment address via the device 100. FIG. 5C is a flowchart illustrating a process P6b for entering and storing the user ID 201 on the server 200 over the communication 11. According to the process P6b, the device 100 may initiate communication with the server 200 over the communication 11 for sign-in to the server 200 (S22a). For example, the device 100 may use a browser to receive a user input of manually entering URI of a web page for sign-in to the server 200 or use an app preliminarily associated with the URI, to load the sign-in page on the device 100. The device 100 may receive a user input of manually entering the user ID on the sing-in page using an input device of the device 100 (S22b). The device 100 may also receive a user input of manually entering the address on the sing-in page using the input device of the device 100 (S22c). The device 100 may send the inputted user ID and the address to the server 200 over the communication 11 (S22d). The transmission of the user ID and address at the step S22d may include sending the user ID and address in response to the user's manual input of the user ID and address. Also, the device 100 may send the device ID 103 that identifies a user's mobile communication device 300 associated with the device 100 to the server 200 over the communication 11 (S22e). The device ID 103 may be automatically sent along with transmission of the user ID and address, if there is any device ID 103 stored on the device 100. The server 200 may then respond to the received user ID, address, and device ID by associating the user ID, address, and device ID together with one another on a storage device of the server 200 (S22f), whereby the server 200 may store the user ID 201, associated address 202, and associated device ID 203. At the step S22f, the server 200 may store the user ID 201, address 202, device ID 203 associated with one another as a form of a database. The process P6b may be advantageous when the device 100 is provided with the input device through which to enter characters to type the user ID and address. The device 100 may also locally store therein the inputted user ID and address as the user ID 101 and address 101a (S22g). The storage at the step S22g may include storing the user ID and address in response to the user's manual input of the user ID and address. At the step S22g, the device 100 may store the user ID 101 and the address 101a associated with one another as a form of a database. In addition to the user ID and address, information associated with the position of the device 100 may be entered by and stored on the device 100. As illustrated in FIG. 5C, the device 100 may receive the position information indicative of the position at which the device 100 is located (S22h). The reception of the position information at the step S22h may include receiving a user input of manually entering description, such as text description, that describes the position using the input of the device 100, or receiving position information obtained using a positioning system in the device 100. The device 100 may then locally store therein the inputted position information as the destination information 106 (S22i).

In some embodiments, the user ID 201 and the associated addresses 202 may be entered and stored on the server 200 over the communications 10 and 11. In the embodiments, the user can sign in to the server 200 from the device 100 using the mobile communication device 300 to register his/her user ID and shipment address via the device 100. FIG. 5D is a flowchart illustrating a process P6c for entering and storing the user ID 201 on the server 200 over the communications 10 and 11. According to the process P6c, the device 100 may initiate the communication 10 with the user's mobile communication device 300 for input of the user ID and address (S23a) and also initiate the communication 11 with the server 200 for sign-in to the server 200 (S23b). The communications 10 and 11 may be established individually, and are not necessarily established concurrently. For example, the device 100 may use an app preliminarily associated with the URI of a web page for sign-in to the server 200. The user's mobile communication device 300 may receive a user input of manually entering the user ID on the sing-in page using an input device of the device 300 (S23c). The user's mobile communication device 300 may also receive a user input of manually entering the address on the sing-in page using the input device of the device 300 (S23d). The user's mobile communication device 300 may send the inputted user ID and the address to the device 100 over the communication 10 (S23e). The transmission of the user ID and address at the step S23e may include sending the user ID and address in response to the user's manual input of the user ID and address. In response to the user ID and address from the user's mobile communication device 300, the device 100 may locally store therein the received user ID and address as the user ID 101 and address 101a (S23f). At the step S23f, the device 100 may store the user ID 101 and the address 101a associated with one another as a form of a database. In parallel to the storage of the user ID and address at the step S23f, the device 100 may send the received user ID and address to the server 200 over the communication 11 (S23g). Also, the device 100 may send the device ID 103 that identifies the user's mobile communication device 300 to the server 200 over the communication 11 (S23h). The device ID 103 may be automatically sent along with transmission of the user ID and address. The server 200 may then respond to the received user ID, address, device ID by associating the user ID, address, device ID together with one another on a storage device of the server 200 (S23i), whereby the server 200 may store the user ID 201, associated address 202, and associated device ID 203. At the step S23i, the server 200 may store the user ID 201, address 202, and device ID 203 associated with one another as a form of a database. The process P6c may be advantageous when the device 100 is not provided with the input device and so needs help of the user's mobile communication device 300 for input of the user ID and address. In addition to the user ID and address, information associated with the position of the device 100 may be entered by and stored on the user's mobile communication device 300. As illustrated in FIG. 5D, the user's mobile communication device 300 may receive the position information indicative of the position at which the device 100 is located (S23j). The reception of the position information at the step S23j may include receiving a user input of manually entering description, such as text description, that describes the position using the input of the device 300, or receiving position information obtained using a positioning system in the device 300. The user's mobile communication device 300 may then send the inputted position information to the device 100 over the communication 10 (S23k), so that the device 100 may respond to the position information by locally storing therein the received position information as the destination information 106 (S231). At the step S231, the device 100 may store the user ID 101 and the destination information 106 associated with one another as a form of a database.

In some embodiments, the user ID 301 and the address 301a stored on the user's mobile communication device 300 may be automatically sent from the device 300 to the device 100 over the communication 10, so that the user ID 101 and the address 101a may be automatically generated on the device 100 on the basis of the received user ID 301 and address 301a. For example, the user's mobile communication device 300 may send the user ID 301 and the address 301a to the device 100 over the communication 10 upon discovery of the device 100 according to the process P5.

### Server ID

In some embodiments, the user's mobile communication device 300 may have an installed therein an app (application) dedicated to performance of the automatic ordering process using the device 300 (i.e., processes P1, P2, P3), in which case the server ID 302 may be preliminary stored on the app by default. The app may include the server ID 302 as part of program code of the app.

In some embodiments, the server ID 302 stored on the user's mobile communication device 300 may be automatically sent from the device 300 to the device 100 over the communication 10, so that the server ID 102 may be automatically generated on the device 100 on the basis of the received server ID 302. For example, the user's mobile communication device 300 may send the server ID 302 to the device 100 over the communication 10 upon discovery of the device 100 according to the process P5.

### User ID, Address, Server ID, Item ID, Category ID, Expiration Information, Destination Information on Tag

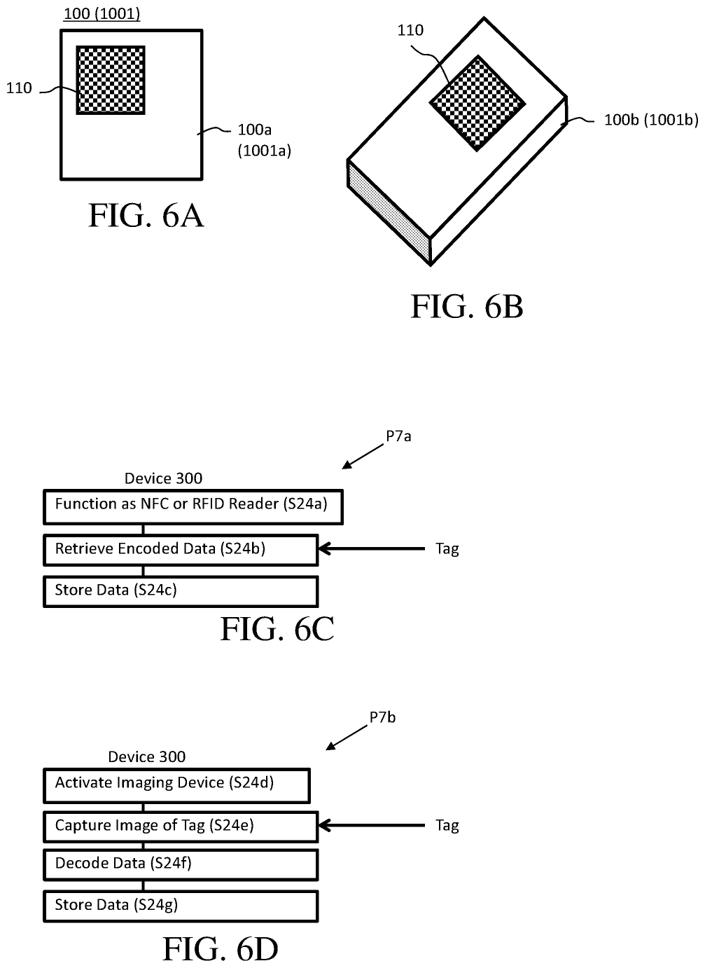

In some embodiments, a tag on which at least one of a user ID, address, server ID, item ID, category ID, and expiration information, and destination information is encoded and readable by the user's mobile communication device 300 may be provided or issued by the seller 3 to the user, so that the user's mobile communication device 300 may retrieve at least one of the user ID, address, server ID, item ID, category ID, expiration information, and destination information by reading the tag. In an aspect, the tag readable by the user's mobile communication device 300 may be attached to the body of the device 100, packaging (e.g. container box, blister pack, etc.) of the device 100, or a document such as a user's manual enclosed with the device 100 in the packaging when the device 100 is sold or shipped to the user. In an aspect where the consumable item is attachable to and detachable or removable from the device 100, the tag readable by the user's mobile communication device 300 may be attached to the body of the consumable item, packaging (e.g. container box, blister pack, etc.) of the consumable item, or a document such as a user's manual enclosed with the consumable item in the packaging when the consumable item is sold or shipped to the user. FIG. 6A schematically illustrates an example of the tag, in which a tag 110 is attached on the body 100a of the device 100 or on the body 1001a of a consumable item 1001 that is attachable to and detachable from the device 100. FIG. 6B schematically illustrates another example of the tag, in which a tag 110 is attached on a package box 100b in which the device 100 is packaged when the device 100 is sold or shipped to the user, or attached on a package box 1001b in which the separated consumable item 1001 is packaged when the consumable item 1001 is sold or shipped to the user. The tag may be an RFID tag (e.g., a NFC tag) on which data (at least one of a user ID, address, server ID, item ID, category ID, expiration information, and destination information) is stored, in which case the user's mobile communication device 300 may retrieve and store the data according to a process P7a as illustrated in FIG. 6C. As illustrated herein, the process P7a may include the device 300 functioning the device 300 as an RFID reader (e.g., a NFC reader) to power and activate the tag (S24a); retrieving the data over an RFID communication (e.g., a NFC communication) from the tag that has been powered and activated (S24b); and storing the retrieved data in a memory of the device 300 (S24c). At the step S24c, the user's mobile communication device 300 may store therein the retrieved user ID as the user ID 301, retrieved address as the address 301a, and/or retrieved server ID as the server ID 302. Alternatively, the tag may include a barcode such as a two-dimensional Quick Response (QR) code that is readable by an imaging device, in which case the user's mobile communication device 300 may retrieve and store the encoded data (at least one of a user ID, address, server ID, item ID, category ID, expiration information, and destination information) according to a process P7b as illustrated in FIG. 6D. As illustrated herein, the process P7b may include the device 300 activating an imaging device such as a built-in camera of the device 300 (S24d); capturing an image of the barcode using the imaging device (S24e); decoding the encoded data from the captured image of the barcode (S24f); and storing the decoded data in a memory of the device 300 (S24g). At the step S24g, the user's mobile communication device 300 may store therein the retrieved user ID as the user ID 301, retrieved address as the address 301a, and/or retrieved server ID as the server ID 302.

The user's mobile communication device 300 may send the user ID, address, server ID, item ID, category ID, expiration information, and/or destination information retrieved from the tag according to the process P7a or P7b to the device 100 over the communication 10. The device 100 may store therein received user ID as the user ID 101, received address as the address 101a, received server ID as the server ID 102, received item ID as the item ID 105, received category ID as the category ID 107, received expiration information as the expiration information 108, and/or received destination information as the destination information 106, respectfully.

### Details of Automatic Ordering: S1

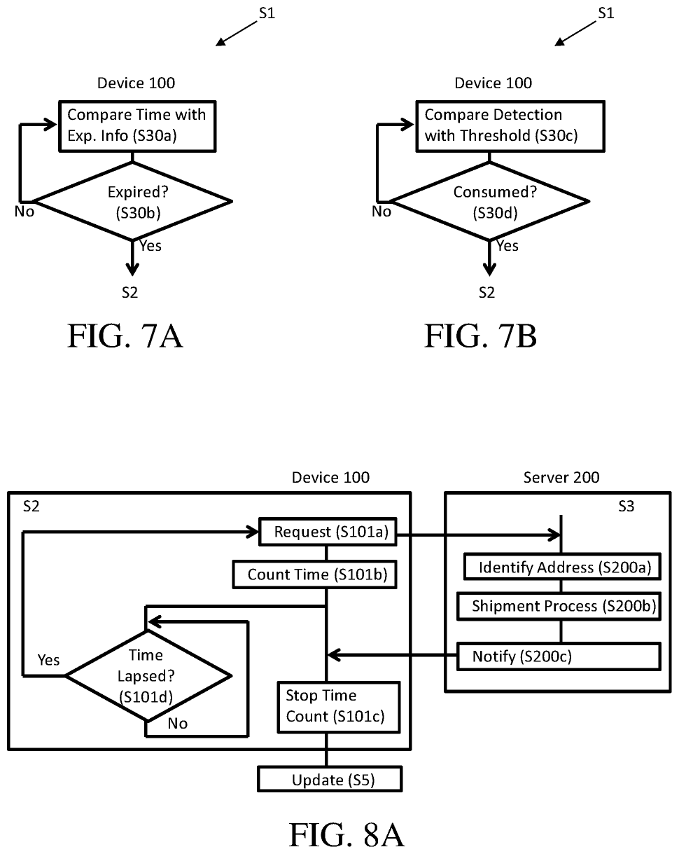

FIG. 7A is a flowchart illustrating a detailed example of the determination at the step S1, according to some embodiments. In the example, the device 100 may operate a timer and continuously (i.e., periodically or at predetermined time intervals) compare the current time with the expiration date indicated by the expiration information 108 (S30a). The device 100 may determine affirmatively at the step S1 upon determining that the current time is equal to or later than the expiration date (S30b: Yes).

FIG. 7B is a flowchart illustrating a detailed example of the determination at the step S1, according to some embodiments. In the example, the device 100 may operate a detector configured to detect consumption of the consumable item associated with the device 100 (S30c). The device 100 may determine affirmatively at the step S1 upon detecting that the consumable item has been consumed over a predetermined threshold (S30d: Yes).

### Details of Automatic Ordering: S2, S3

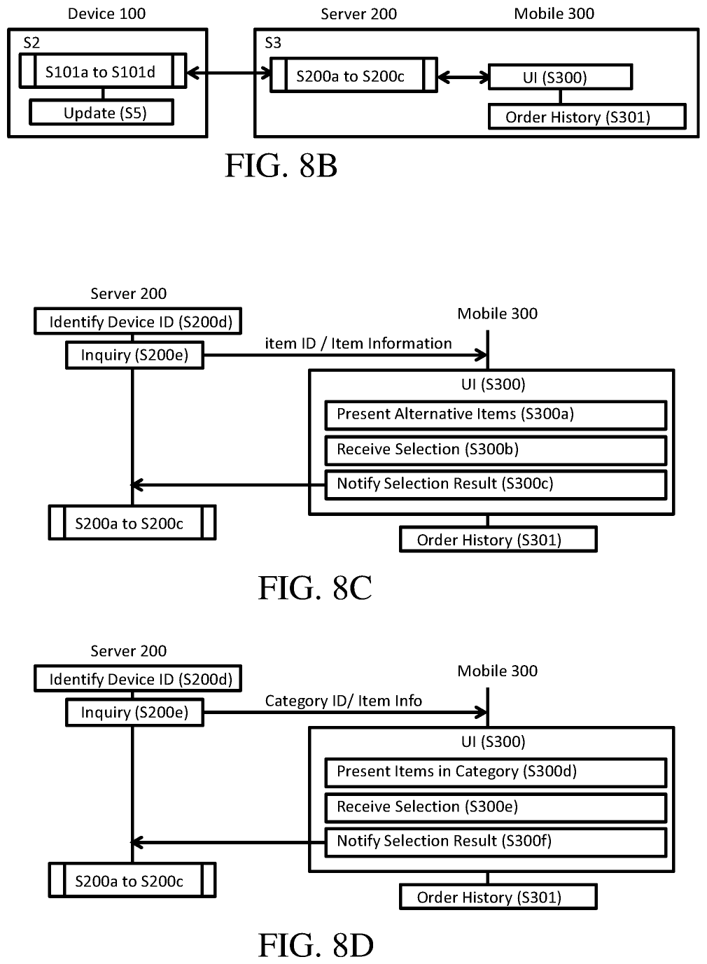

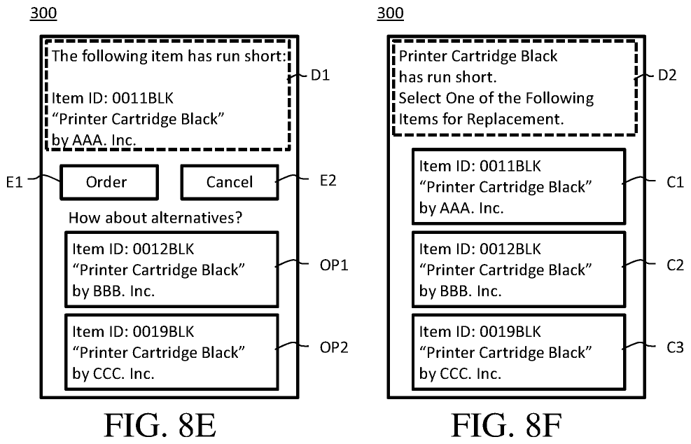

FIG. 8A is a flowchart illustrating a detailed example of the issuance of the order at the step S2, according to some embodiments. In the example, the device 100 may automatically issue and send a request for shipment of a new one of a consumable item to the server 200 over the communication 11 (S101a). The shipment request at the step S101a may be addressed to the server ID 102. The shipment request at the step S101a may include the user ID 101 to identify who is ordering the consumable item. The shipment request at the step S101a may include the device ID of the device 100 to identify what device is ordering the consumable item. The device ID may be the identifier that uniquely identifies the requester (the device 100) over the communication 11. An example of the device ID may include the IP address allocated to the device 100. The shipment request at the step S101a may include the item ID 105 to identify the product identity of the consumable item. The shipment request at the step S101a may include the category ID 107 to identify what product category the consumable item belongs to. The shipment request at the step S101a may include the destination information 106 to identify the destination of a new one of a consumable item requested at the step S101a. In response to receipt of the shipment request, the server 200 may identify the address of the requester (i.e., the user of the device 100 which has issued the request at the step S101a) as a shipping address (S200a). The server 200 may then perform a shipment process to ship or deliver the ordered consumable item to the identified shipping address (S200b). Upon completion of the shipment process, the server 200 may issue and send a notification indicative of the completion of the shipment process to the device 100 over the communication 11 (S200c).

At the step S200a, the server 200 may identify the address with reference to the user IDs 201 and addresses 202. More specifically, the identification at the step S200a may include comparing the user ID contained in the request (i.e., user ID 101) with the user IDs 201 to identify one of the user IDs 201 which matches the user ID 101, and then identifying one of the addresses 202 that is associated with the identified user ID 201 as the shipping address.

The request issued at the step S101a may include the address 101a associated with the user ID 101, in which case the identification at the step S200a may include the server 200 identifying the address 101a as the shipping address.

The request issued at the step S101a may include the item ID 105, in which case the shipment process at the step 220b may include the server 200 performing the shipment process to ship a consumable item identified by the item ID 105 with reference to the database DB1. More specifically, the server 200 may identify a consumable item by identifying an item ID in the database DB1 which matches the item ID 105, and perform the shipment process to ship the identified consumable item.

After the issuance of the request at the step S101a, the device 100 may initiate counting a predetermined time period (e.g., thirty seconds, one minute, etc.) to wait for the notification from the server 200 as to the completion of the shipment process (S101b). In response to the notification issued by the server 200 at the step S200c, the device 100 may terminate the time counting (S101c). While failing to receive the notification from the server 200, the device 100 may determine whether or not the device 100 has counted the predetermined time period (S101d). Upon having counted the predetermined time period (S101d: Yes), the device 100 may repeat the transmission of the request at the step S101a, since failure to receive the notification from the server 200 for the predetermined time period may indicate some trouble in arrival of the request at the server 200. The notification at the step S200c may include the expiration information 208 associated with the consumable item shipped at the step S200b, in which case the update at the step S5 may include updating the expiration information 108 with the expiration information 208 contained in the notification.

FIG. 8B is a flowchart illustrating another detailed example of the issuance of the order at the step S2, according to some embodiments. In the example, the server 200 may send an inquiry to the user of the device 100 through his/her user's mobile communication device 300 as to shipment of a new one of a consumable item in the course of the shipment process S3. The server 200 may perform the shipment process (S200a, S200b, S200c) in accordance with a response from the user's mobile communication device 300 in reply to the inquiry. As illustrated in FIG. 8B, the shipment process S3 may include activation or presentation of a user interface (UI) by the user's mobile communication device 300 to prompt the user to identify a consumable item the user wants to be shipped by the seller 3 (S300), in addition to the shipment process steps (S200a, S200b, S200c). The user's mobile communication device 300 may generate and store therein the order history 305 associated with an order for a consumable item which has been identified by the user through the UI at the step S300 (S301).

FIG. 8C is a flowchart illustrating an example of the shipment process S3 with the steps S300 and S301 in more detail, according to some embodiments. In the embodiments, the shipment request (order) issued by the device 100 at the step S101a may include the item ID 105 that identifies the consumable item associated with the device 100. In response to the shipment request, the server 200 may identify a user's mobile communication device 300 (S200d), and issue and send an inquiry to the user's mobile communication device 300 over the communication 12 (S200e) prior to performance of the steps S200b. At the steps S200d and S200e, the server 200 may identify the device ID 203 associated with the user ID 101 contained in the shipment request, and address the inquiry to the identified device ID 203. The inquiry may include information associated with a consumable item identified by the item ID 105 that is contained in the shipment request. In response to the inquiry, the user's mobile communication device 300 may activate a UI that presents the consumable item identified by the item ID 105 and one or more other consumable items alternative thereto (S300a), prompting the user to select one of the presented items (S300b). In some aspects, each item belonging to the same category as the consumable item identified by the item ID 105 may be presented as an alternative consumable item. In case the user's mobile communication device 300 has access to the database DB1, the inquiry may simply include the item ID 105, so that the device 300 may identify the product name, brand name, etc. of the consumable item identified by the item ID 105 and also identify the product name, brand name, etc. of each alternative consumable item that belongs to the same product category with reference to the database DB1, for presentation of those product information on the UI (S300a). Alternatively, in case the user's mobile communication device 300 does not have access to the database DB1, the server 200 may identify the product name, brand name, etc. of the consumable item identified by the item ID 105 and the product name, brand name, etc. of each alternative consumable item with reference to the database DB1, so that the inquiry may include those product information that is then presented by the user's mobile communication device 300 on the UI (S300a). The user's mobile communication device 300 may receive a user input through the UI to select one of the presented items (i.e., one of the consumable item identified by the item ID 105 and other alternative consumable items) (S300b). The user's mobile communication device 300 may generate and send a response message that includes information indicative of the selected consumable item to the server 200 over the communication 12 (S300c). The response message may include the item ID that identifies the selected consumable item. In response, the server 200 may perform the shipment process to ship the selected consumable item with reference to the item ID contained in the response message (S200a, S200b, S200c). FIG. 8E schematically illustrates a GUI activated or displayed on the display of the device 300 at the step S300a, according to some embodiments. The GUI may include a description D1 that describes that the consumable item identified by the item ID 105 needs to be replaced with a new one. The GUI may also include GUI elements E1 and E2. Selection of the GUI elements E1 may invoke selection of the consumable item identified by the item ID 105, namely, issuance of the response message that includes the item ID 105 (S300c). Selection of the GUI element E2 may invoke issuance of a negative response message that indicates that the user wants none of the consumable items to be shipped, in response to which the server 200 may fail to perform the shipment process. The GUI may also include one or more GUI elements (e.g., OP1, OP2) each of which indicates an identified alternative consumable item. Selection of one of the GUI elements OP1 and OP2 may invoke selection of a corresponding alternative consumable item, namely, issuance of the response message that includes the item ID of the selected alternative consumable item. The inquiry issued at the step S200e may include the destination information 106 that is originally contained in the shipment request, with reference to which the user's mobile communication device 300 may display the destination of the ordered consumable item on the GUI.

FIG. 8D is a flowchart illustrating another example of the shipment process S3 with the steps S300 and S301 in more detail, according to some embodiments. In the embodiments, the shipment request (order) issued by the device 100 at the step S101a may include the category ID 107 that identifies the product category to which the consumable item associated with the device 100 belongs. In response to the shipment request, the server 200 may identify a user's mobile communication device 300 (S200d), and issue and send an inquiry to the user's mobile communication device 300 over the communication 12 (S200e) prior to performance of the steps S200b. The inquiry may include information associated with the product category identified by the category ID 107 that is contained in the shipment request. In response to the inquiry, the user's mobile communication device 300 may activate a UI that presents one or more consumable items which belong to the product category identified by the category ID 107 (S300d), prompting the user to select one of the presented items (S300e). In case the user's mobile communication device 300 has access to the database DB1, the inquiry may simply include the category ID 107, so that the device 300 may identify the product name, brand name, etc. of each of the consumable items in the product category identified by the category ID 107 with reference to the database DB1, for presentation of those product information on the UI (S300d). Alternatively, in case the user's mobile communication device 300 does not have access to the database DB1, the server 200 may identify the product name, brand name, etc. of each of the consumable items in the product category identified by the category ID 107 with reference to the database DB1, so that the inquiry may include those product information that is then presented by the user's mobile communication device 300 on the UI (S300d). The user's mobile communication device 300 may receive a user input through the UI to select one of the presented items (S300e). The user's mobile communication device 300 may generate and send a response message that includes information indicative of the selected consumable item to the server 200 over the communication 12 (S300f). The response message may include the item ID that identifies the selected consumable item. In response, the server 200 may perform the shipment process to ship the selected consumable item with reference to the item ID contained in the response message (S200a, S200b, S200c). FIG. 8F schematically illustrates a GUI activated or displayed on the display of the device 300 at the step S300d, according to some embodiments. The GUI may include a description D2 that describes that the consumable item identified by the category ID 107 needs to be replaced with a new one. The GUI may also include one or more GUI elements (e.g., C1, C2, C3) each of which indicates an identified consumable item in the product category identified by the category ID 107. Selection of one of the GUI elements C1, C2, and C3 may invoke selection of a corresponding consumable item, namely, issuance of the response message that includes the item ID of the selected consumable item. The inquiry issued at the step S200e may include the destination information 106 that is originally contained in the shipment request, with reference to which the user's mobile communication device 300 may display the destination of the ordered consumable item on the GUI.

### Details of Automatic Ordering: S7, S8, S3

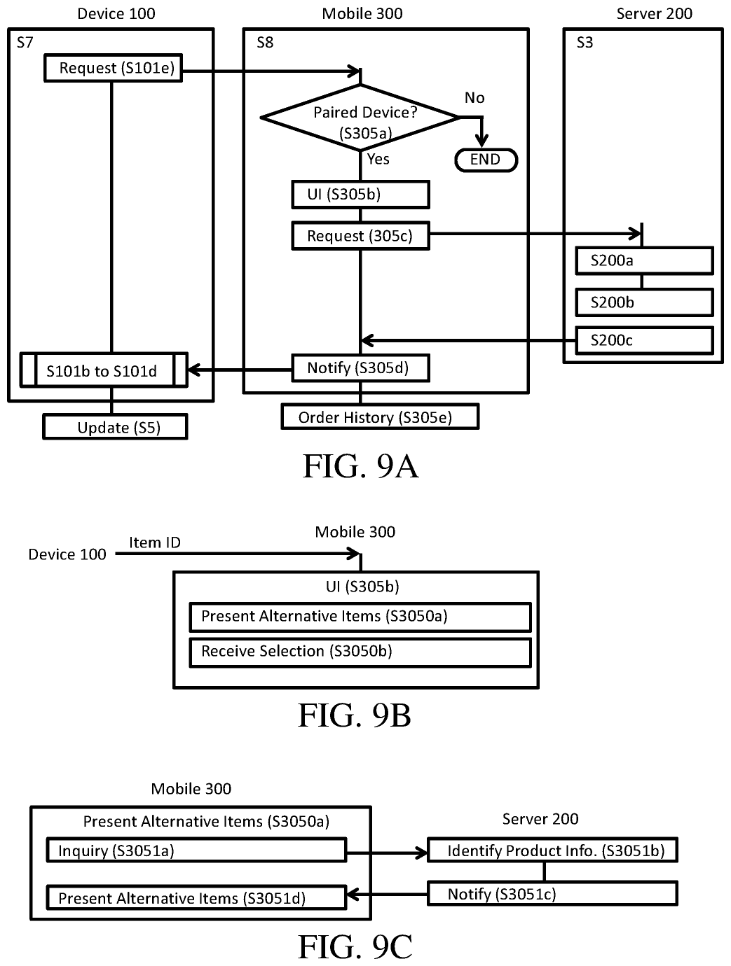

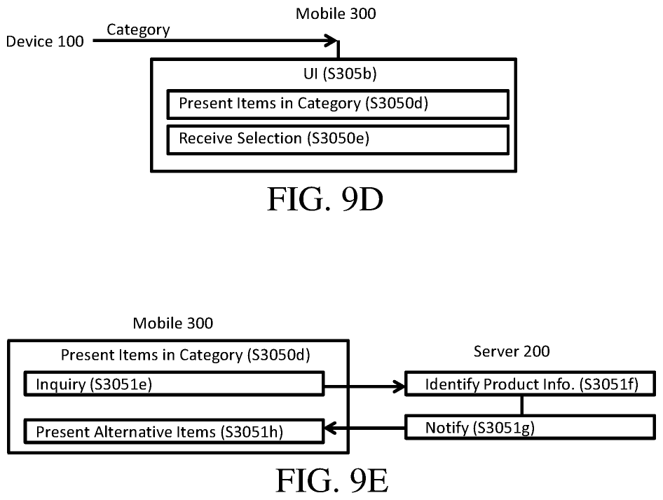

FIG. 9A is a flowchart illustrating a detailed example of the issuance of the orders at the steps S7 and S8, according to some embodiments. In the example, the device 100 may automatically issue and send a request for shipment of a new one of a consumable item to the paired user's mobile communication device 300 over the communication 10 (S101e). The shipment request at the step S101e may be addressed to the device ID 103. The shipment request issued at the step S101e may include the user ID 101, the device ID of the device 100, the item ID 105, the category ID 107, and/or the destination information 106, just as the shipment request issued at the step S101a may do. In response to receipt of the shipment request, the user's mobile communication device 300 may determine whether the cast requester (i.e., the device 100) is paired with the device 300, namely, determine whether the shipment request is issued by a device 100 paired with the device 300 (S305a). The determination at the step S305a may include comparing the device ID 303 with the device ID 103 contained in the shipment request, in which case the determination may be affirmative if the compared device IDs match one another. Upon determination negatively that the shipment request is not issued by a paired device 100 (S305a: No), the user's mobile communication device 300 may fail to issue a shipment request to the server 200. Upon determining affirmatively (S305a: Yes), the user's mobile communication device 300 may activate a UI to prompt the user to identify a consumable item he/she wants to be shipped by the seller 3 (S305b). The user's mobile communication device 300 may then issue a shipment request for a consumable item selected through the UI to the server 200 over the communication 12 (S305c). In response to the shipment request, the server 200 may identify the shipping address for the user of the device 100 (S200a) and perform the shipment process (S200b). Upon completion of the shipment process, the server 200 may issue and send a notification indicative of the completion of the shipment process to the user's mobile communication device 300 over the communication 12 (S200c). In response, the user's mobile communication device 300 may issue and send a notification indicative of the completion of the shipment process to the device 100 over the communication 10 (S305d). The user's mobile communication device 300 may generate the notification (S305d) by copying or duplicating the notification received from the server 200, or may forward the received notification to the device 100. Also, the user's mobile communication device 300 may generate and store therein the order history 305 associated with an order for a consumable item which has been identified by the user through the UI at the step S305b (S305e).

FIG. 9B is a flowchart illustrating a detailed example of the user selection through UI at the step S305b, according to some embodiments. In the embodiments, the shipment request issued by the device 100 at the step S101e may include the item ID 105. The user's mobile communication device 300 may present the consumable item identified by the item ID 105 and one or more other consumable items alternative thereto on the UI (S3050a). In some aspects, each item belonging to the same category as the consumable item identified by the item ID 105 may be presented as an alternative consumable item. The user's mobile communication device 300 may identify the product name, brand name, etc. of the consumable item identified by the item ID 105 and also identify the product name, brand name, etc. of each alternative consumable item that belongs to the same product category, for presentation of those product information on the UI (S3050a), prompting the user to select one of the presented items (S3050b). In case the user's mobile communication device 300 has access to the database DB1, the user's mobile communication device 300 may identify the product names, brand names, etc. of the consumable items with reference to the database DB1. Alternatively, in case the user's mobile communication device 300 does not have access to the database DB1, the user's mobile communication device 300 may identify the product names, brand names, etc. of the consumable items with the help of the server 200. More specifically, the user's mobile communication device 300 may issue and send an inquiry including the item ID 105 to the server 200 over the communication 12 (S3051a) as illustrated in FIG. 9C. The inquiry may include the item ID 105. In this case, the server 200 may respond to the inquiry by identifying the product name, brand name, etc. of the consumable item identified by the item ID 105 and also identifying the product name, brand name, etc. of each alternative consumable item that belongs to the same product category (S3051b), and send back those identified product information to the user's mobile communication device 300 (S3051c). In response, the user's mobile communication device 300 may present the notified product information on the UI (S3051d). The user's mobile communication device 300 may then receive a user input through the UI to select one of the presented items (i.e., one of the consumable item identified by the item ID 105 and other alternative consumable items) (S3050b). At the step S305c, the user's mobile communication device 300 may issue the shipment request for the consumable item selected at the step S3050b. The user's mobile communication device 300 may generate and send the shipment request that includes information indicative of the selected consumable item to the server 200 over the communication 12 (S305c). The shipment request may include the item ID that identifies the selected consumable item. In response, the server 200 may perform the shipment process to ship the selected consumable item with reference to the item ID contained in the shipment request (S200a, S200b, S200c). FIG. 8E schematically illustrates a GUI activated or displayed on the display of the device 300 at the step S3050a, according to some embodiments. The GUI may include a description D1 that describes that the consumable item identified by the item ID 105 needs to be replaced with a new one. The GUI may also include GUI elements E1 and E2. Selection of the GUI elements E1 may invoke selection of the consumable item identified by the item ID 105, namely, issuance of the shipment request that includes the item ID 105 (S305c). Selection of the GUI element E2 may invoke issuance of a negative response message that indicates that the user wants none of the consumable items to be shipped, in response to which the server 200 may fail to perform the shipment process. The GUI may also include one or more GUI elements (e.g., OP1, OP2) each of which indicates an identified alternative consumable item. Selection of one of the GUI elements OP1 and OP2 may invoke selection of a corresponding alternative consumable item, namely, issuance of the shipment request that includes the item ID of the alternative consumable item (S305c).

FIG. 9C is a flowchart illustrating another detailed example of the user selection through UI at the step S305b, according to some embodiments. In the embodiments, the shipment request issued by the device 100 at the step S101e may include the category ID 107. The user's mobile communication device 300 may present one or more consumable items which belong to the product category identified by the category ID 107 on the UI (S3050d). The user's mobile communication device 300 may identify the product name, brand name, etc. of each of the consumable items in the product category identified by the category ID 107, for presentation of those product information on the UI (S3050d), prompting the user to select one of the presented items (S3050e). In case the user's mobile communication device 300 has access to the database DB1, the user's mobile communication device 300 may identify the product names, brand names, etc. of the consumable items with reference to the database DB1. Alternatively, in case the user's mobile communication device 300 does not have access to the database DB1, the user's mobile communication device 300 may identify the product names, brand names, etc. of the consumable items with the help of the server 200. More specifically, the user's mobile communication device 300 may issue and send an inquiry including the category ID 107 to the server 200 over the communication 12 (S3051e) as illustrated in FIG. 9E. The inquiry may include the category ID 107. In this case, the server 200 may respond to the inquiry by identifying the product name, brand name, etc. of each consumable item in the product category identified by the category ID 107 (S305 if), and send back those identified product information to the user's mobile communication device 300 (S3051g). In response, the user's mobile communication device 300 may present the notified product information on the UI (S3051h). The user's mobile communication device 300 may then receive a user input through the UI to select one of the presented items (S3050e). The user's mobile communication device 300 may generate and send the shipment request that includes information indicative of the selected consumable item to the server 200 over the communication 12 (S305c). The shipment request may include the item ID that identifies the selected consumable item. In response, the server 200 may perform the shipment process to ship the selected consumable item with reference to the item ID contained in the shipment request (S200a, S200b, S200c). FIG. 8F schematically illustrates a GUI activated or displayed on the display of the device 300 at the step S305b, according to some embodiments. The GUI may include a description D2 that describes that the consumable item identified by the category ID 107 needs to be replaced with a new one. The GUI may also include one or more GUI elements (e.g., C1, C2, C3) each of which indicates an identified consumable item in the product category identified by the category ID 107. Selection of one of the GUI elements C1, C2, and C3 may invoke selection of a corresponding consumable item, namely, issuance of the shipment request that includes the item ID of the consumable item.

### Details of Automatic Ordering: S9, S10, S3

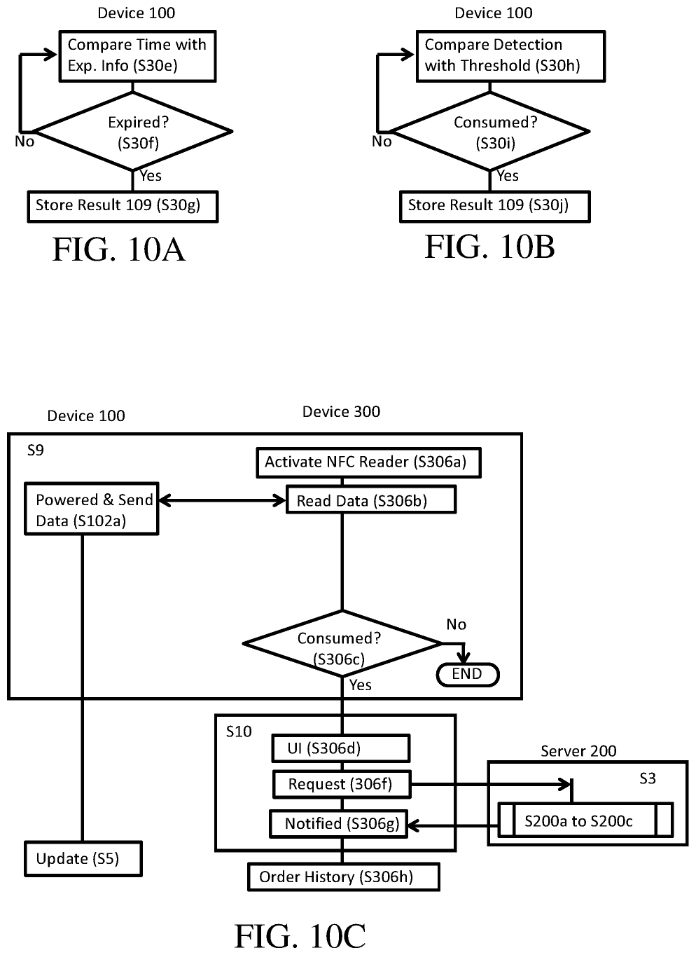

FIGS. 10A, 10B, and 10C are flowcharts illustrating a detailed example of the issuance of the orders at the steps S9 and S10, according to some embodiments. In the embodiments, the device 100 may periodically generate or update the determination result 109. As illustrated in FIG. 10A, the device 100 may operate a timer and continuously (i.e., periodically or at predetermined time intervals) compare the current time with the expiration date indicated by the expiration information 108 (S30e). Upon determining that the current time is equal to or later than the expiration date (S30f: Yes), the device 100 may update the determination result 109 to indicate that “the consumable item has been consumed”, for example, by changing the bit from “0” to “1” (S30g). Alternatively or in addition, as illustrated in FIG. 10B, the device 100 may operate a detector configured to detect consumption of the consumable item associated with the device 100 (S30h). Upon detecting that the consumable item has been consumed over a predetermined threshold (S30i: Yes), the device 100 may update the determination result 109 to indicate that “the consumable item has been consumed”, for example, by changing the bit from “0” to “1” (S30j). In the embodiments, the determination information 109 may be stored on an overwritable RFID or NFC tag that is attached or affixed to the consumable item. At the step S30g or S30j, the device 10 may update the determination information 109 by overwriting the determination information 109 on the RFID or NFC tag. The RFID tag may also store therein the user ID 101, address 101a, server ID 102, device ID 103, item ID 105, category ID 107, and expiration information 108.

In the embodiments, the step S9 may include the user's mobile communication device 300 functioning as a RFID reader (e.g., a NFC reader) to power and activate the tag (S306a) and retrieving the determination information 109 and/or expiration information 108 over an RFID communication (e.g., a NFC communication) from the tag that has been powered and activated (S306b). In the embodiments, in the step S9, the RFID tag on the device 100 may be powered and activated by the user's mobile communication device 300 to send the determination information 109 and/or expiration information 108 over the RFID communication for the retrieval by the device 300 (S102a). The user's mobile communication device 300 may then determine whether or not the consumable item needs to be replaced with a new one with reference to the retrieved determination information 109 and/or expiration information 108 (S306c). In an example, the determination at the step S306c may be affirmative if the bit of the determination information 109 is “1” indicative of “consumed”. In another example, the determination at the step S306c may be affirmative if the current date is equal to or later than the expiration date indicated by the expiration information 108, in which case the user's mobile communication device 300 may operate a timer and compare the current time indicated by the timer with the expiration date indicated by the expiration information 108. Upon determining that the consumable item needs to be replaced with a new one (S306c: Yes), the user's mobile communication device 300 may activate a UI to prompt the user to identify a consumable item he/she wants to be shipped by the seller 3 (S306d). The user's mobile communication device 300 may then issue a shipment request for a consumable item selected through the UI to the server 200 over the communication 12 (S306f). In response to the shipment request, the server 200 may identify the shipping address for the user of the device 100 (S200a) and perform the shipment process (S200b). Upon completion of the shipment process, the server 200 may issue and send a notification indicative of the completion of the shipment process to the user's mobile communication device 300 over the communication 12 (S200c). In response, the user's mobile communication device 300 may provide a notification indicative of the completion of the shipment process (S306g). The user's mobile communication device 300 may generate and store therein the order history 305 associated with an order for a consumable item which has been identified by the user through the UI at the step S306d (S306h).

At the step S306b, the user's mobile communication device 300 may retrieve the item ID 105 stored on the tag. At the step S306d, the user's mobile communication device 300 may present the consumable item identified by the item ID 105 and one or more other consumable items alternative thereto on the UI, according to the steps S3050a and S3050b just as the device 300 may do at the step S305b discussed above.

At the step S306b, the user's mobile communication device 300 may retrieve the category ID 107 stored on the tag. At the step S306d, the user's mobile communication device 300 may present the consumable items identified by the category ID 107 on the UI, according to the steps S3050d and S3050e just as the device 300 may do at the step S305b discussed above.

### Aspects of Destination Information

The destination information 106 may be used to let the user be aware of the destination of a new one of a consumable item which has been shipped to the user according to the step S3. In some embodiments, the destination information 106 may be displayed on a GUI, for example, on the GUI for presenting consumable items associated with the consumable item identified by the item ID 105 or category ID 107 as discussed above with reference to FIGS. 8E and 8F, along with other GUI elements.

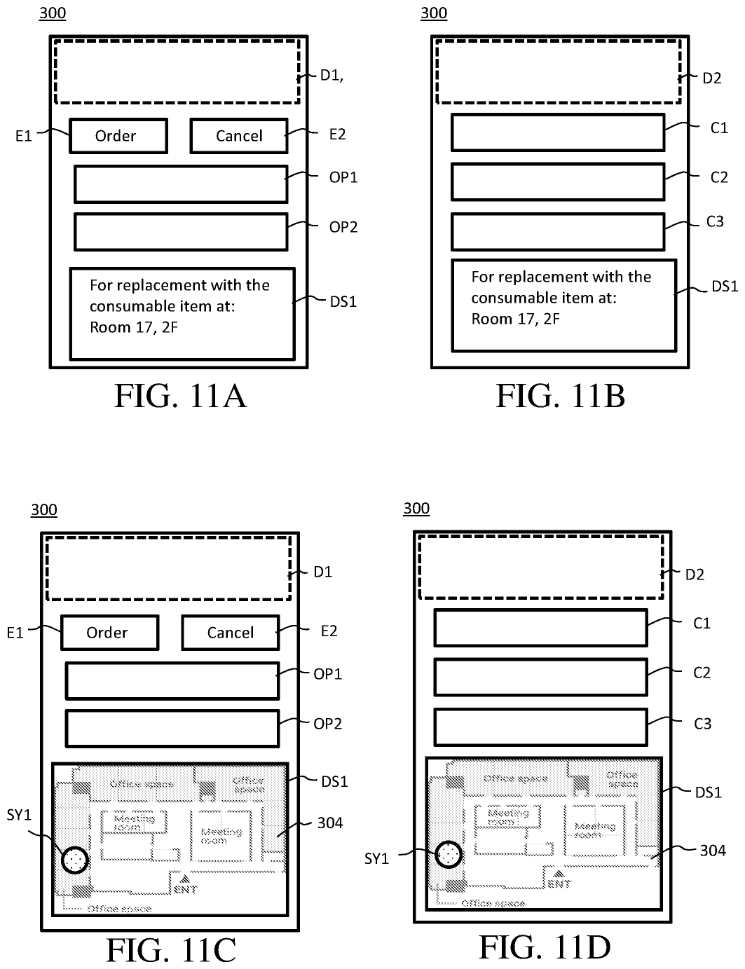

The destination information 106 may be a text description entered by the user that describes the detailed location to which the consumable item belongs. FIG. 11A schematically illustrate an example of the presentation of the destination DS1 based on the text description in the GUI illustrated in FIG. 8E (i.e., GUI for presentation of the consumable item identified by the item ID 105 and one or more alternative consumable items). The GUI may include the presentation of the destination DS1 in a text manner that displays the text description in addition to the dialog D1 and the GUI elements E1, E2, OP1, and OP2. FIG. 11B schematically illustrate an example of the presentation of the destination DS1 based on the text description in the GUI illustrated in FIG. 8F (i.e., GUI for presentation of one or more consumable items in the product category identified by the category ID 107). The GUI may include the presentation of the destination DS1 in a text manner that displays the text description in addition to the dialog D2 and the GUI elements C1, C2, and C3.

The destination information 106 may be position information indicative of a position at which the consumable item resides with respect to the map 304, namely, the coordinates at which the consumable item is placed in the map 304. The position information may be generated by the user manually plotting a symbol of the consumable item in the map 304. The destination information 106 may be geographical positioning information indicative of a position of the consumable item obtained by use of a global positioning system (GPS) and/or an indoor positioning system (IPS). The geographical positioning information may be indicative of the latitude and longitude coordinates at which the consumable item is placed. The map 304 may contain the latitude and longitude coordinates for each of positions over the area represented by the map 304, so that the position of the consumable item can be identified and plotted in the map 304 by comparing the coordinates of the consumable item with the sets of the coordinates of the positions within the area of the map 304. FIG. 11C schematically illustrates an example of the presentation of the destination DS1 with the map 304 based on the position information in the GUI illustrated in FIG. 8E (i.e., GUI for presentation of the consumable item identified by the item ID 105 and one or more alternative consumable items). The GUI may include the presentation of the destination DS1 in a graphical manner that displays the map 304 and a symbol SY1 placed at the position represented by the position information over the map 304, in addition to the dialog D1 and the GUI elements E1, E2, OP1, and OP2. FIG. 11D schematically illustrates an example of the presentation of the destination DS1 with the map 304 based on the position information in the GUI illustrated in FIG. 8F (i.e., GUI for presentation of one or more consumable items in the product category identified by the category ID 107). The GUI may include the presentation of the destination DS1 in a graphical manner that displays the map 304 and a symbol SY1 placed at the position represented by the position information over the map 304, in addition to the dialog D2 and the GUI elements C1, C2, and C3.

In some embodiments, the destination information 106 may be included in the order history 305 to allow the user to check the destination of an ordered consumable item by displaying the order history 305 on the user's mobile communication device 300 after he/she has ordered the consumable item. In the embodiments, at the step S301, the user's mobile communication device 300 may store the destination information 106 contained in the inquiry on the order history 305. Similarly, at the step S305e, the user's mobile communication device 300 may store the destination information 106 contained in the shipment request on the order history 305. Further similarly, at the step S306h, the user's mobile communication device 300 may store the destination information 106 retrieved from the tag (S306b) on the order history 305. In some embodiments, the user's mobile communication device 300 may display the order history 305 on the display thereof in response to a user request any time, in order for the user to check the destination of a consumable item when the consumable item arrives at the user's address.

### Management of User IDS and Devices in Server 200

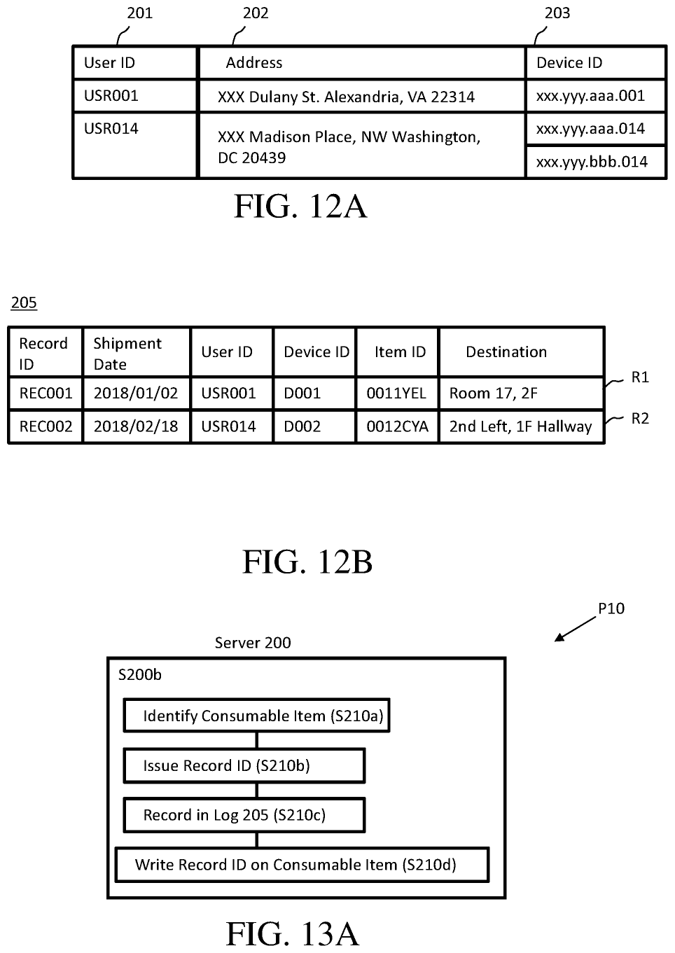

In some embodiments, the server 200 may manage one or more devices 100 used by a user or under control of the user, for each user. The device IDs of one or more devices 100 may be associated with a user ID 201 corresponding to the user of the devices 100 as a form of a database on the server 200, so that the server 200 may identify what devices 100 are under control of the users with reference to the database. The listed devices 100 on the database may be identified as the devices 100 which expect to issue a shipment request at S101a or S101e, namely, from which the server 200 expects to receive a shipment request. Each device ID identifies a corresponding device 100 as a destination of data transmission over the communication 11, so that the server 200 may transmit data to a device 100 over the communication 11 by addressing the data to a corresponding device ID. In the example illustrated in FIG. 12A, one device ID “xxx.yyy.aaa.001” identifying a corresponding device 100 is associated with the user ID “USR001” and its associated address 202, while two device IDs “xxx.yyy.aaa.014” and “xxx.yyy.bbb.014” identifying respective corresponding devices 100 are associated with the user ID “USR014” and its corresponding address 202. In the embodiments, the sever 200 may update the device ID by receiving the device ID from the device 100 and associating the received device ID with a corresponding user ID 201. In an aspect, the device ID of the device 100 may be automatically sent to the server 200 when the user ID or the associated address is sent to the server 200 over the communication 11 according to the process P6b or P6c, so that the server 200 may store therein the received device ID associated with the user ID 201. At the step S22f or S23i, the server 200 may store therein the received device ID associated with the user ID 201 and the address 202. In the aspect, the registration of the device ID can be achieved along with the registration of the user ID and address on the server 200. The registration of the device ID in this aspect may be performed at a specific time during the operation of the device 100, for example, upon initialization of the device 100.

### Shipment Log 205

FIG. 12B schematically illustrates an example of the shipment log 205, according to some embodiments. The shipment log 205 may list one or more shipment records that identify respective corresponding shipment processes that were performed individually according to the step S3. Each record in the shipment log 205 may include: the date on which the shipment process was conducted (Shipment Date); the user ID for which the shipment process was conducted (User ID); the device ID that identifies the device 100 associated with the consumable item for which the shipment process was conducted (Device ID); the item ID that identifies the product model of the consumable item for which the shipment process was conducted (Item ID); and the destination to which the consumable item is intended to finally arrive (Destination). The shipment date may indicate the date on which the consumable item departed from the seller 3 (e.g., a warehouse or equivalent facility having inventory of the consumable item under control of the seller 3) on the basis of shipment of the consumable item, the date on which the consumable item arrived at the destination address (i.e., the address identified at the step S200a), etc. The user ID listed in the shipment log 205 may correspond to the user ID contained in the shipment request issued at the step S101a, S305c, or S306f or in the notification issued at the step S300c or S300f based on which the server 200 performed the shipment process. The device ID listed in the shipment log 205 may correspond to the device ID contained in the shipment request issued at the step S101a, S305c, or S306f or in the notification issued at the step S300c or S300f based on which the server 200 performed the shipment process. In the example illustrated in FIG. 12B, the shipment log 205 is listing two shipment records R1 and R2: the record R1 identified by the record ID “REC001” indicates that there was a shipment of the consumable item identified by “0011YEL” to user ID “USR001” with the destination to “Room 17, 2F” on Jan. 2, 2018, while the record R2 identified by the record ID “REC002” indicates that there was a shipment of the consumable item identified by “0012CYA” to user ID “USR014” with the destination to “2nd Left, 1F Hallway” on Feb. 18, 2018.

In the embodiments, the server 200 may update the shipment log 205 in the shipment process at the step S3. The shipment process at the S3 may include inputting a record of the performed shipment process in the shipment log 205.

### Management of Consumable Item Using Record ID

In some embodiments, the record ID issued and assigned to a record of a shipment process in the shipment log 205 as discussed above may be electronically written on the consumable item shipped according to the shipment process for management of the shipped consumable item. A record ID is issued and assigned to a specific record of shipment process, and thus functions as a reference to a shipment process that has invoked delivery of the consumable item with the record ID attached thereto. In the embodiments, the shipment process at the step S200b may include writing the issued record ID on a memory of the consumable item, so that the record ID is stored on the consumable item. FIG. 13A is a flowchart illustrating an example of a process P10 for the storage of the record ID on the consumable item in the course of the shipment process. As illustrated herein, the shipment process at the step S200b may include identifying a consumable item requested by the shipment request issued at the step S101a, S305c, or S306f or by the notification issued at the step S300c or S300f (S210a). At the step S210a, the server 200 may identify a consumable item specified by the item ID contained the shipment request or notification. The shipment process at the step S200b may further include issuing a new record ID assigned to a shipment of the consumable item identified at the step S210a (S210b), and generating a record identified by the issued record ID in the shipment log 205 (S210c). At the step S210c, the server 200 may issue every new record ID that consists of one or more letters, numbers, other symbols, a combination thereof, etc., that are selected at random, or selected according to a predetermined specific rule. The server 200 may then provide an output of the issued record ID for the record ID to be written on a memory of the identified consumable item ready to be shipped (S210d).

### Monitor of Consumable Item

Constant purchases of a new one of the consumable item by the user according to the automatic ordering process are the key to continuous business revenue of the seller 3. Accordingly, if the user chooses to replenish or refill an exhausted consumable item by himself or herself or chooses to buy a new one of the consumable item or an alternative item from a downtown retail store and replace the exhausted item with the new one instead of performance of the automatic ordering process, it would produce financial damage to the seller 3. Therefore, in some embodiments, the server 200 may monitor, examine, or inspect the device 100 as to whether or not the user has replenished or refilled an exhausted consumable item or replaced with a new one of a consumable item without performing the automatic ordering process. The server 200 may restrict or prohibit use of the device 100 associated with the consumable item conditionally depending on the result of the monitoring so as to ensure performance of the automatic ordering process.

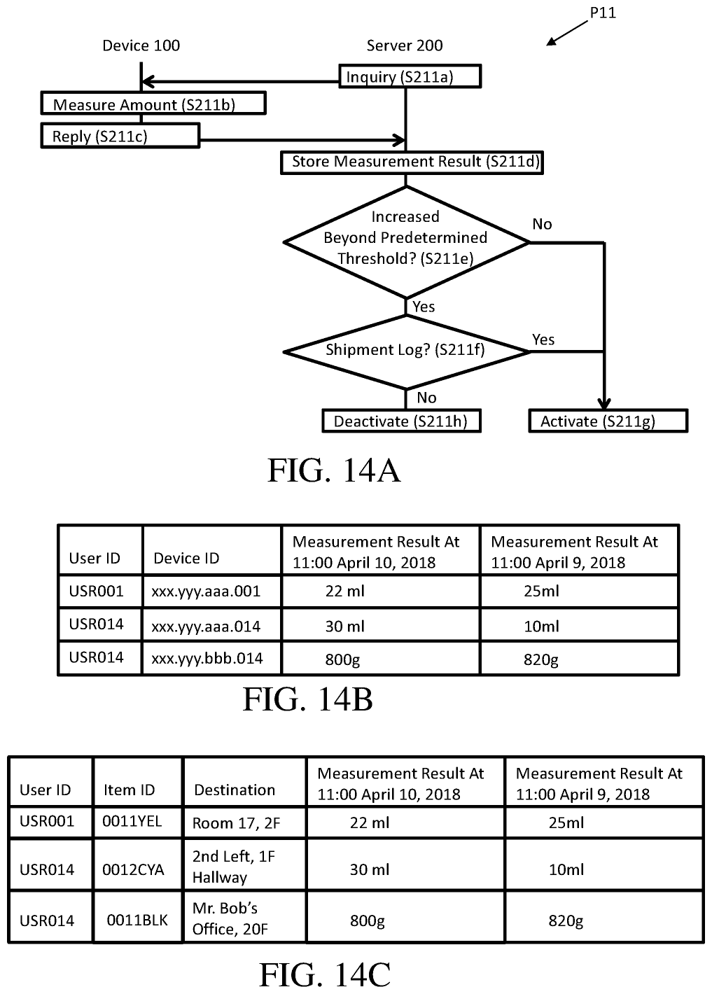

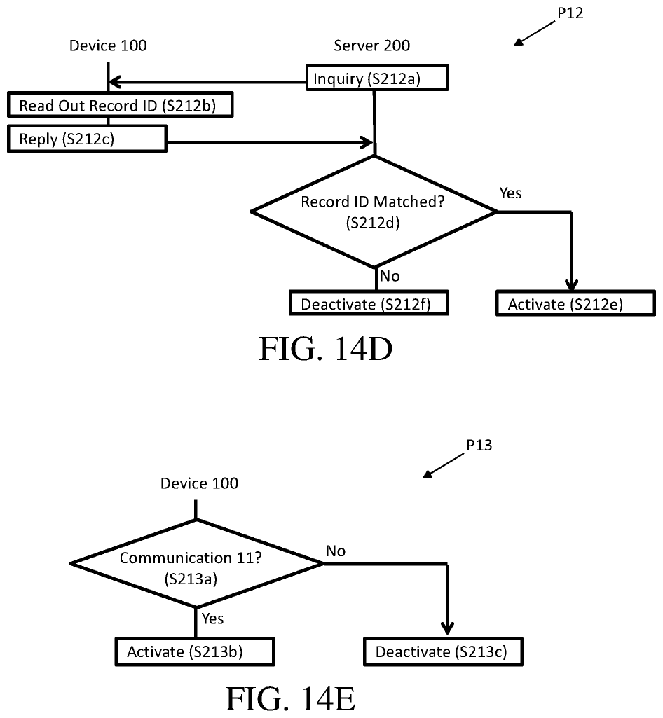

In the embodiments where the consumable item contains content consumable by the device 100 that is able to be measured in the amount, the server 200 may monitor the consumable item by monitoring increase in the amount of the content of the consumable item, using the shipment log 205. FIG. 14A is a flowchart illustrating an example of a process P11 for monitoring the consumable item by the server 200 over the communication 11. As illustrated herein, the server 200 may periodically, regularly, or at predetermined time intervals send an inquiry as to the amount of the content of the consumable item to each one of the devices 100 identified by the device IDs 203 over the communication 11 (S211a). The server 200 may regularly (e.g., every two hours, once in a day, etc.) establish the communication 11 with the devices 100 for the inquiry. At the step S211a, the server 200 may address the same inquiries to the device IDs 203 in turns or in sequence, or substantially concurrently with one another. In response to the inquiry, the device 100 may measure the amount of the content of the consumable item held by itself (S211b), and send back to the server 200 a reply that contains the result of the measurement over the communication 11 (S211c). At the step S211c, the device 100 may perform the measurement and transmission of the reply every time the device 100 receives the inquiry. The reply at the step S211c may include the user ID 101 of the device 100 along with the measurement result for identification of the replier. The reply at the step S211c may further include at least one of the device ID, the item ID 105, and the destination information 106 of the device 100 as well as the user ID 101 for further detailed identification of the replier. In response to a reply from each device 100, the server 200 may store the measurement result associated with the user ID 101 and at least one of the device ID, item ID, destination information contained in the reply (S211d). The storage at the step S211d may include accumulatively storing at least two measurement results replied at the neighboring time points over the predetermined time interval as a record, for each user ID. FIG. 14B schematically illustrates an example of a record of the measurement results accumulatively stored associated with the user ID and the device ID at the step S211d. The illustrated example shows that there are entries of two measurement results of “22 ml” replied at 11:00 on Apr. 10, 2018 and of “25 ml” replied at 11:00 on Apr. 9, 2018 for the device 100 identified by the device ID “xxx.yyy.aaa.001” of the user identified by the user ID “USR001”; there are entries of two measurement results of “30 ml” replied at 11:00 on Apr. 10, 2018 and of “10 ml” replied at 11:00 on Apr. 9, 2018 for the device 100 identified by the device ID “xxx.yyy.aaa.014” of the user identified by the user ID “USR014”; and there are entries of two measurement results of “800 g” replied at 11:00 on Apr. 10, 2018 and of “820 g” replied at 11:00 on Apr. 9, 2018 for the device 100 identified by the device ID “xxx.yyy.bbb.014” of the user identified by the user ID “USR014”. Note that, in the illustrated example, the amount of the content of the consumable item held by the devices 100 identified by the device IDs “xxx.yyy.aaa.001” and “xxx.yyy.aaa.014” is measured and indicated by milliliter (ml), whereas the amount of the content of the consumable item held by the device 100 identified by the device ID “xxx.yyy.bbb.014” is measured and indicated by gram (g). FIG. 14C schematically illustrates an example of a record of the measurement results accumulatively stored associated with the user ID, item ID, and destination information at the step S211d. The illustrated example shows that there are entries of two measurement results of “22 ml” replied at 11:00 on Apr. 10, 2018 and of “25 ml” replied at 11:00 on Apr. 9, 2018 for the consumable item identified by the item ID “0011YEL” with the destination to “Room 17, 2F” for the user identified by the user ID “USR001”; there are entries of two measurement results of “30 ml” replied at 11:00 on Apr. 10, 2018 and of “10 ml” replied at 11:00 on Apr. 9, 2018 for the consumable item identified by the item ID “0012CYA” with the destination to “2nd Left, 1F Hallway” for the user identified by the user ID “USR014”; and there are entries of two measurement results of “800 g” replied at 11:00 on Apr. 10, 2018 and of “820 g” replied at 11:00 on Apr. 9, 2018 for the consumable item identified by the item ID “011BLK” with the destination to “Mr. Bob's Office, 20F” for the user identified by the user ID “USR014”. Upon newly storing a measurement result, the server 200 may determine whether or not there is increase by more than a predetermined threshold in the amount of the content of the consumable item indicated by the newly stored measurement result, compared to the amount of the same indicated by the previously stored measurement result (S211e). Upon determining negatively that there is no increase beyond the predetermined threshold in the new measurement result compared to the previous measurement result (S211e: No), the server 200 may fail to restrict use of the corresponding device 100 (i.e., the device 100 identified by the user ID and the device ID, or the device 100 identified by the user ID, item ID, and destination information, in the measurement result record), allowing the device 100 to keep in operation (S211g). On the other hand, upon determining affirmatively that there is increase beyond the predetermined threshold in the new measurement result from the previous measurement result (S211e: Yes), the server 200 may then determine whether or not there is a record of shipment process for the corresponding device 100 with the shipment date within predetermined days before the date of the newly replied measurement result (S211f). At the step S211f, the server 200 may determine if there is a record of shipment process for the corresponding device 100 with the shipment date being between the date of the newly replied measurement result and the date of the previously replied measurement result, with reference to the shipment log 205. Upon determining affirmatively that there is such shipment process record for the corresponding device 100 (S211f: Yes), the server 200 may fail to restrict use of the device 100 allowing the device 100 to keep in operation (S211g). On the other hand, upon determining negatively that there is no such shipment process record for the corresponding device 100 (S211f: No), the server 200 may restrict the use of the device 100, enforcing the device 100 to stop its operation (S211h). The restriction at the step S211h may include the server 200 sending to the device 100 over the communication 11 a specific command that instructs the device 100 to stop its operation by addressing the command to the corresponding device ID of the device 100, in which case the device 100 may be configured to respond to the command by stopping its operation. Upon the enforced stop of the operation, the device 100 may provide a dialog to notify the user of the enforced stop on a GUI on the device 100. For example, referring to FIG. 14B, when the server 200 finds that there is increase beyond the predetermined threshold in the measurement result at 11:00 on Apr. 10, 2018 compared to the previous measurement result at 11:00 on Apr. 9, 2018 for the device 100 identified by the user ID “USR014” and the device ID “xxx.yyy.aaa.014” (S211e: Yes), the server 200 further determines if there is a shipment process record for the user ID “USR014” and the device ID “xxx.yyy.aaa.014” with the shipment date being between 11:00 on Apr. 9, 2018 and 11:00 on Apr. 10, 2018 (S211f). If there is no such shipment process record (S211f: No), the server 200 restricts use of the device 100 identified by the user ID “USR014” and the device ID “xxx.yyy.aaa.014”. In another example, referring to FIG. 14C, when the server 200 finds that there is increase beyond the predetermined threshold in the measurement result at 11:00 on Apr. 10, 2018 compared to the previous measurement result at 11:00 on Apr. 9, 2018 for the device 100 identified by the user ID “USR014” associated with the consumable item identified by the item ID “0012CYA” and the destination information “2nd Left, 1F Hallway” (S211e: Yes), the server 200 further determines if there is a shipment process record having the user ID “USR014”, the item ID “0012CYA”, and the destination information “2nd Left, 1F Hallway” with the shipment date being between 11:00 on Apr. 9, 2018 and 11:00 on Apr. 10, 2018 (S211f). If there is no such shipment process record (S211f: No), the server 200 restricts use of the device 100 identified by the user ID “USR014” associated with the item ID “0012CYA” and the destination information “2nd Left, 1F Hallway”. A sequence of the determination and restriction at the steps S211e through S2311h is based on the notion that, if there is such shipment process record, it is assumed that the amount of the content of the consumable item has increased because the exhausted consumable item was replaced with a new one that had been delivered to the user as a result of performance of the recorded shipment process, whereas if there is no such shipment process record, it is assumed that the increase in the amount of the content of the consumable item is caused by the user having replenished, refilled, or replaced the exhausted consumable item without performance of a shipment process.

In the embodiments where every shipped consumable item is managed using a record ID that is issued by the seller 3 according to the process P10, the server 200 may monitor the consumable item by monitoring the record ID written on the consumable item, using the shipment log 205. FIG. 14D is a flowchart illustrating an example of a process P12 for monitoring the consumable item by the server 200 over the communication 11. As illustrated herein, the server 200 may periodically, regularly, or at predetermined time intervals send an inquiry as to the record ID stored on the consumable item to each one of the devices 100 identified by the device IDs 203 over the communication 11 (S212a). The server 200 may regularly (e.g., every two hours, once in a day, etc.) establish the communication 11 with the devices 100 for the inquiry. At the step S212a, the server 200 may address the same inquiries to the device IDs 203 in turns or in sequence, or substantially concurrently with one another. In response to the inquiry, the device 100 may read out a record ID stored on the consumable item held by itself (S212b), and send back to the server 200 a reply that contains the record ID over the communication 11 (S212c). At the step S212c, the device 100 may perform the readout and transmission of the reply every time the device 100 receives the inquiry. The reply at the step S212c may include the user ID 101 of the device 100 along with the record ID for identification of the replier. The reply at the step S212c may further include at least one of the device ID, the item ID 105, and the destination information 106 of the device 100 as well as the record ID 101 for further detailed identification of the replier. In response to a reply from each device 100, the server 200 may determine whether or not the record ID in the reply matches the record ID in the shipment log 205 for the device 100 identified by the reply (S212d). In an aspect, the determination at the step S212d may include: identifying one or more shipment records having the user ID and the device ID which match the user ID and the device ID contained in the reply; identifying the most recent shipment record out of the one or more shipment records; comparing the record ID assigned to the most recent shipment record with the record ID contained in the reply, to see if the both record IDs are identical. In another aspect, the determination at the step S212d may include: identifying one or more shipment records having the user ID, item ID, and destination information which match the user ID, item ID, and destination information contained in the reply; identifying the most recent shipment record out of the one or more shipment records; comparing the record ID assigned to the most recent shipment record with the record ID contained in the reply, to see if the both record IDs are identical. Upon determining affirmatively (S212d: Yes), the server 200 may fail to restrict use of the corresponding device 100 (i.e., the device 100 identified by the user ID and the device ID, or the device 100 identified by the user ID, item ID, and destination information, contained in the reply), allowing the device 100 to keep in operation (S212e). On the other hand, upon determining negatively (S212d: No), the server 200 may restrict use of the corresponding device 100, enforcing the device 100 to stop its operation (S212f). The restriction at the step S212f may include the server 200 sending to the device 100 over the communication 11 a specific command that instructs the device 100 to stop its operation by addressing the command to the corresponding device ID of the device 100, in which case the device 100 may be configured to respond to the command by stopping its operation. Upon the enforced stop of the operation, the device 100 may provide a dialog to notify the user of the enforced stop on a GUI on the device 100. For example, when the reply issued at the step S212c contains the user ID “USR001” and the device ID “xxx.yyy.aaa.001”, the server 200 compares the record ID contained in the reply with the record ID assigned to the most recent shipment having the user ID “USR001” and the device ID “xxx.yyy.aaa.001” to determine if the record IDs match one another (S212d). If the record IDs do not match (S212d: No), the server 200 restricts use of the device 100 identified by the user ID “USR001” and the device ID “xxx.yyy.aaa.001” (S212f). In another example, referring to FIG. 14C, when the reply issued at the step S212c contains the user ID “USR001”, the item ID “0011YEL”, and the destination information “Room 17, 2F”, the server 200 compares the record ID contained in the reply with the record ID assigned to the most recent shipment having the user ID “USR001”, the item ID “0011YEL”, and the destination information “Room 17, 2F” to determine if the record IDs match one another (S212d). If the record IDs do not match (S212d: No), the server 200 restricts use of the device 100 identified by the user ID “USR001” associated with the item ID “0011YEL” and the destination information “Room 17, 2F” (S212f). A sequence of the determination and restriction at the steps S212d through S212f is based on the notion that, if the record IDs match, it is assumed that the consumable item duly delivered to the user as a result of the recorded recent shipment process is held by the device 100, whereas if the record IDs do not match, it is assumed that a consumable item obtained by the user without performance of the shipment process is held by the device 100.

A modification can be made to the process P12 in some aspects. In an aspect, the determination at the step S212d may include identifying a predetermined number of the most recent shipment records (e.g., two recent shipment records), instead of one most recent shipment record; and comparing the record ID contained in the reply with the record IDs assigned to the predetermined number of the most recent shipment records, to see if the record ID contained in the reply matches one of the record IDs of the recent shipment records. This may be advantageous for the following reason. It typically takes a day or more for a consumable item delivered according to a shipment process to arrive at the user. Accordingly, when the process P12 is performed soon after the consumable item was shipped to the user, the record ID contained in the reply will be determined not to match the record ID in the shipment log 205 at the step S212d despite performance of the shipment process because the shipped consumable item has not arrived at the user yet and so the device 100 is still holding an exhausted consumable item on which an obsolete record ID is stored. According to the modified process P12 even in the above case, the record ID contained in the reply will be determined to match the obsolete record ID which is stored on the exhausted consumable item still held by the device 100.

In another aspect of modification, the process P12 may include determination as to increase in the amount of the content of the consumable item according to the steps S211a through S211e prior to the determination at the step S212d, so that the determination at the step S212d is performed only when there is increase beyond a predetermined threshold in the amount of the content of the consumable item. This may be also advantageous for the following reason. It typically takes a day or more for a consumable item delivered according to a shipment process to arrive at the user. Accordingly, when the process P12 is performed soon after the consumable item was shipped to the user, the record ID contained in the reply will be determined not to match the record ID in the shipment log 205 at the step S212d despite performance of the shipment process because the shipped consumable item has not arrived at the user yet and so the device 100 is still holding an exhausted consumable item on which an obsolete record ID is stored. According to the modified process P12, the determination at the step S24d will be performed after there is increase in the amount of the content of the consumable item that shows high possibility that the shipped consumable item has arrived at the user and has been replaced with the exhausted item.

### Voluntary Conditional Restriction of Use of Device 100

In the embodiments, the device 100 may be configured to operate only when the communication 11 is kept established between the device 100 and the server 200 to prevent the device 100 from evading the monitoring according to the process P11 or P12 by disconnecting from the server 200. FIG. 14E is a flowchart illustrating an example of a process P13 for a voluntary examination or inspection of the establishment of the communication 11 by the device 100 for activation or deactivation of the device 100. As illustrated herein, according to the process P13, the device 100 may periodically or at predetermined time intervals monitor whether or not the communication 11 is kept established with the server 200 (S213a). The monitoring at the step S213a may include the device 100 sending a polling signal to the server 200 over the communication 11 to wait for a response to be sent back by the server 200, in which case the device 100 may determine that the communication 11 with the server 200 is kept established upon a successful receipt of the response. Upon determining that the communication 11 is kept established with the server 200 (S213a: Yes), the device 100 may keep the device 100 activated, i.e., in operation (S213b), whereas the device 100 may deactivate the device 100 upon determining that the communication 11 is not kept established with the server 200 (i.e., disconnected from the server 200) (S213c). The deactivation herein may include controlling the device 100 in a software manner from operating.

### Shipment Process

In some embodiments, the shipment process at the step S200b may comprise a variety of steps for shipment of the consumable item, besides the steps S210a through S210d discussed above.

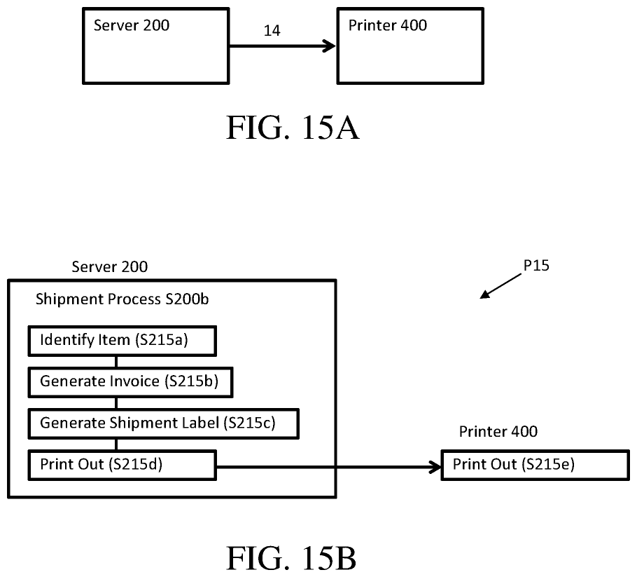

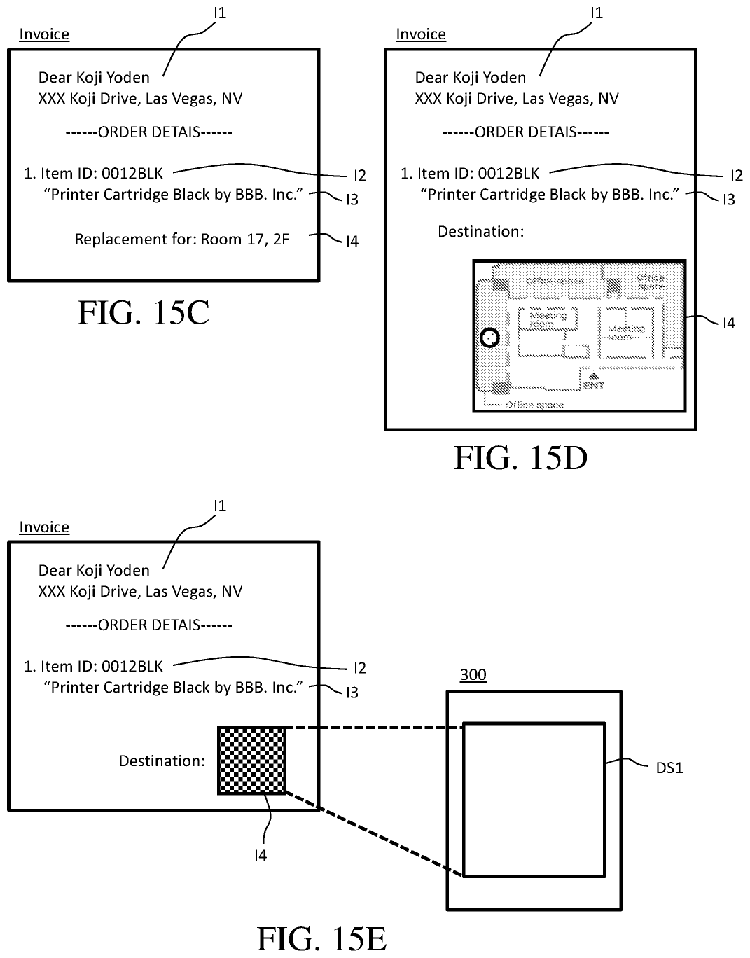

In an aspect, the server 200 may be in connection with a printer 400 over a wired or wireless communication 14, as illustrated in FIG. 15A. The communication 14 may be a close-range wireless communication over a WLAN, PAN, etc. just like the communication 10, or a WAN just like the communication 11 or 12. The communication 14 may be a wired communication via a physical cable. The printer 400 may be a device configured to print text or graphics on paper or other printing material, which may be situated or installed in a facility associated with the seller 3, such as an office or warehouse under control of the seller 3, a delivery or courier service provider outsourced by the seller 3, etc. FIG. 15B is a flowchart illustrating some steps in the shipment process S200b according to the aspect. The shipment process S200b may include the server 200 identifying an item for the shipment process, for example, by name, item ID, etc. (S215a). The identification at the step S215a may include identifying the name of the consumable item requested by the shipment request issued at the step S101a, S305c, or S306f or by the notification issued at the step S300c or S300f. The shipment process may include generating an invoice that describes details on a shipment, including the name of the consumable item identified at the step S215a, the address identified at the step S200a, etc. (S215b). The invoice may be a description or statement of the shipment of the ordered consumable item, which may be designed to be enclosed with the consumable item in a package thereof. The shipment process may include generating a shipment label that describes the address to which the consumable item is delivered according to the shipment process (S215c). The shipment label may be description of the delivery destination, which is designed to be attached to a package of the consumable item. The shipment process may further include instructing the printer 400 to print out the generated invoice and shipment label (S215d). At the S215d, the server 200 may send a print-out request to the printer 400 over the communication 14, so that the printer 400 may respond to the request by printing out the invoice and shipment label (S215e). At the step S215e, the printer 400 may print out the invoice on paper in a manner suitable for being enclosed with the consumable item in the delivery package. At the step S215e, the printer 400 may print out the shipment label on adhesive paper in a manner suitable for being attached to the surface of the delivery package. FIGS. 15C and 15D schematically illustrate respective examples of the invoice generated at the step S215b. As illustrated herein, the invoice may include a printed address I1 to which the ordered consumable item is directed, which corresponds to the address identified at the step S200a; a printed item ID I2 that identifies a product model of the consumable item; a printed item name I3 that is the name of the consumable item; and printed presentation of the destination information I4 describing the final destination of the consumable item, which corresponds to the destination information 106, just as the presentation DS1 discussed above in FIGS. 8A, 8B, 8C, and 8D. As illustrated in FIG. 15C, the destination information I4 may be presented in a text manner just like the presentation DS1 discussed above in FIGS. 11A and 11B. As illustrated in FIG. 15D, the destination information I4 may be presented in a graphical manner that displays a map and a symbol placed at the destination position in the map just like the presentation DS1 discussed above in FIGS. 11C and 11D. FIG. 15E schematically illustrate another example of the invoice generated at the step S215b. In the example, the destination information I4 is a printed barcode on which the destination information 106 is encoded. The barcode 14 is readable by the user's mobile communication device 300, so that the device 300 may display on a display of the device 300 the presentation of the destination information DS1 by reading the barcode 14 and decoding the encoded destination information.

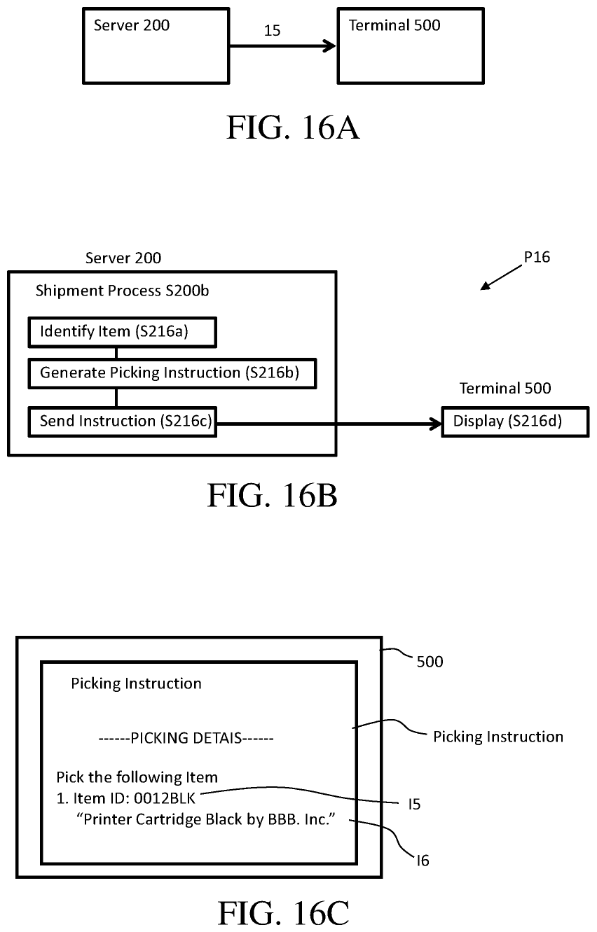

In an aspect, the server 200 may be in connection with a seller staff's terminal 500 over a wired or wireless communication 15, as illustrated in FIG. 16A. The communication 15 may be a close-range wireless communication over a WLAN, PAN, etc. just like the communication 10, or a WAN just like the communication 11 or 12. The terminal 500 may be a device that provides aid for picking of ordered items by a picker staff working for the seller 3. The terminal 500 may be a mobile terminal normally held or carried by the picker staff in a warehouse, or may be a display device installed at a given position in the warehouse. FIG. 16B is a flowchart illustrating some steps in the shipment process S200b according to the aspect. The shipment process S200b may include the server 200 identifying an item for the shipment process, for example, by name, item ID, etc. (S216a). The identification at the step S216a may include identifying the name of the consumable item as requested by the shipment request issued at the step S101a, S305c, or S306f, or by the notification issued at the step S300c or S300f. The shipment process may include generating a picking instruction that describes details on an item the picker staff is responsible for picking (S216b). The picking instruction may include presentation of information such as the name and item ID of the consumable item identified at the step S216a, so that the picker staff is notified of the details of the consumable item he/she is responsible for picking. The shipment process may include sending the generated picking instruction to the terminal 500 over the communication 15 (S216c), so that the terminal 500 may respond to the picking instruction by displaying the received picking instruction on a display of the terminal 500 to visually notify the picker staff of the consumable item he/she should pick in the warehouse (S216d). FIG. 16C schematically illustrates an example of the picking instruction displayed on the terminal 500. As illustrated herein, the picking instruction may include presentation of the item ID I5 and the name I6 of the consumable item identified at the step S216a. The shipment process enables the picker staff and other related staffs of the seller 3 to pack the consumable item picked with reference to the picking instruction along with the printed-out invoice in a package, and attach the printed-out shipment label on the package, to complete preparation for shipment of the ordered consumable item. At the step S216d, the terminal 500 may provide an audio notification through a loudspeaker of the terminal 500 as to the consumable item the picker staff should pick, alternatively to or in addition to the visual notification on the display of the terminal 500.

### Examples of Hardware Configuration

In general, there are a variety of examples for implementation of hardware and/or software components to build the device 100, server 200, and device 300.

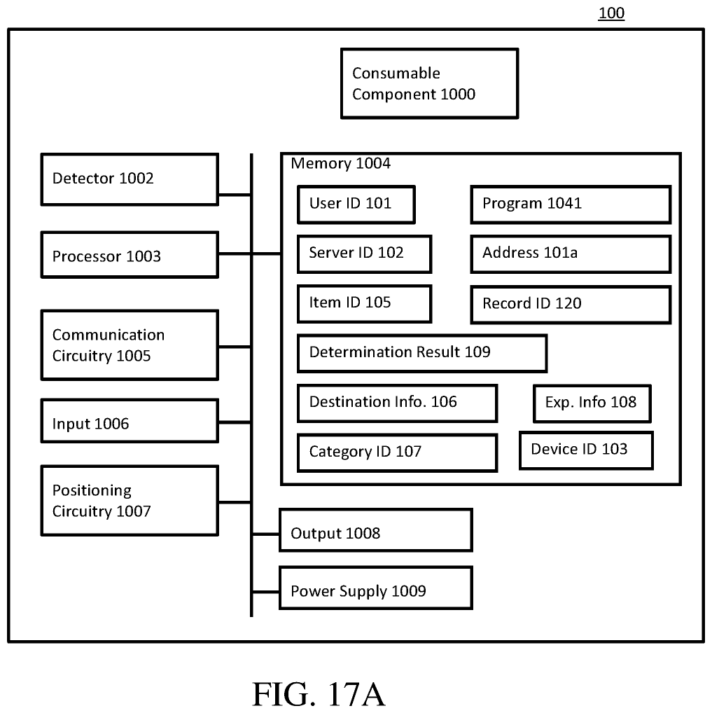

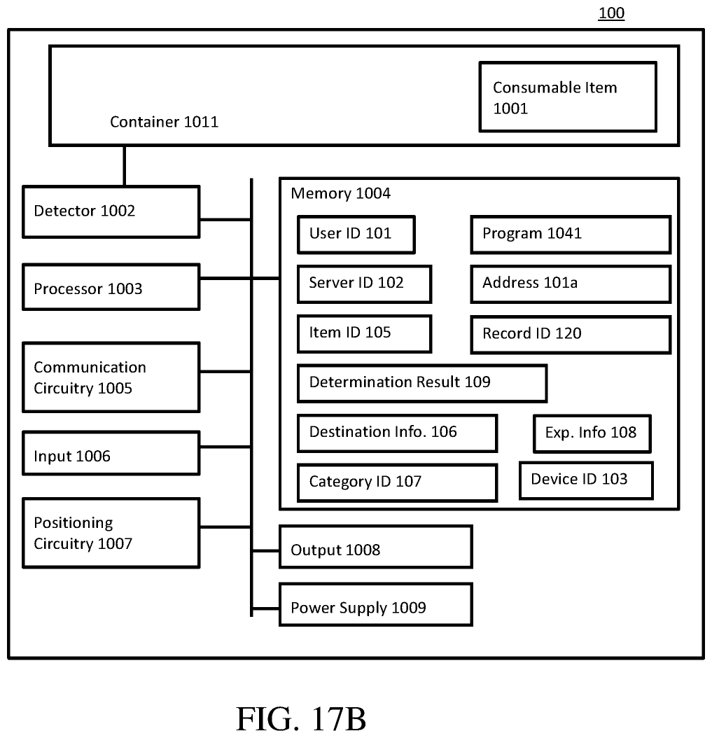

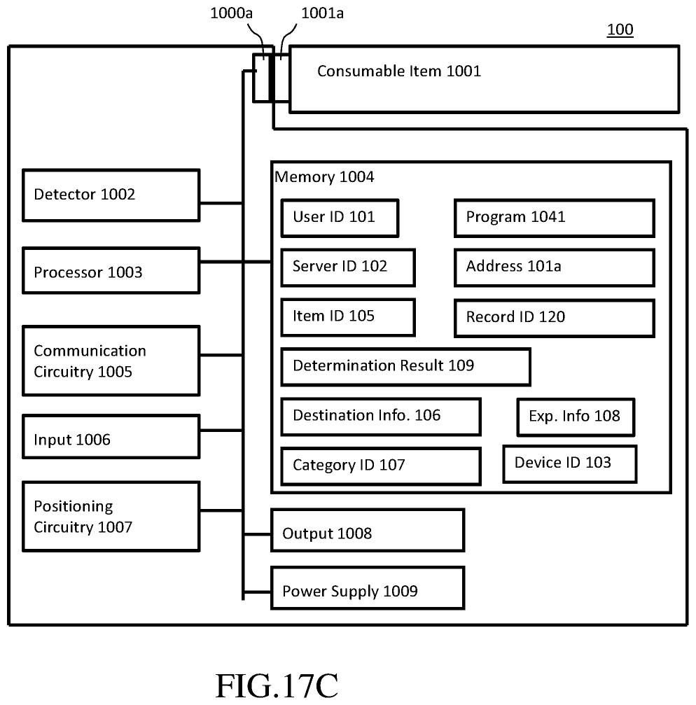

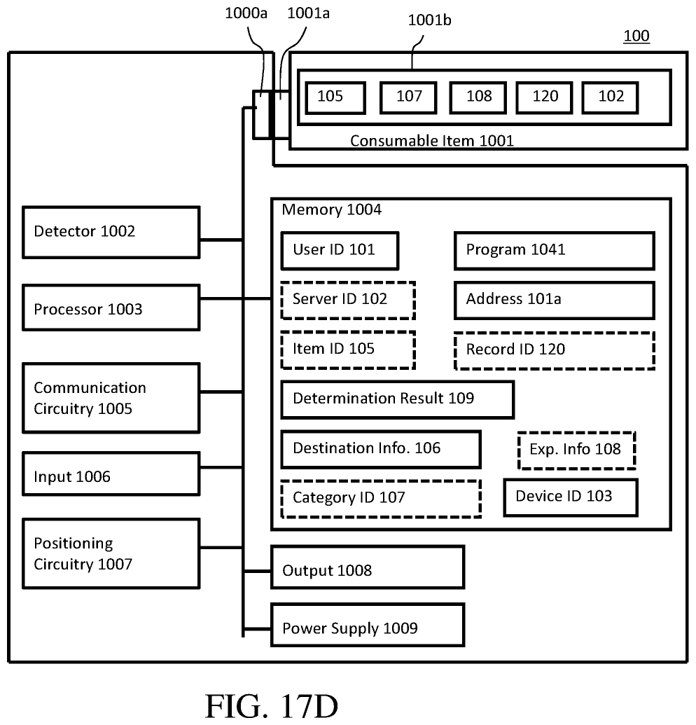

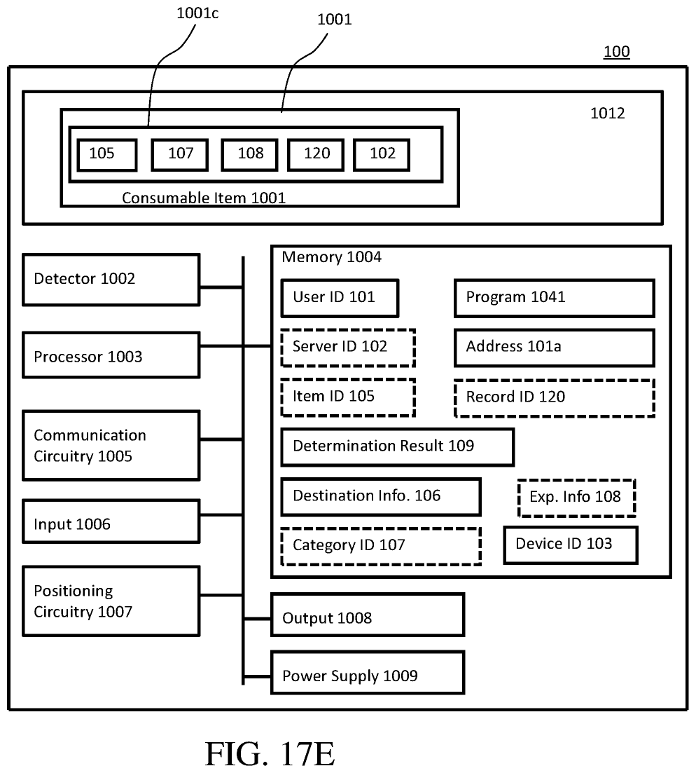

FIG. 17A is a block diagram illustrating an example of the hardware and/or software components of the device 100, according to some embodiments where the device 100 is the consumable item itself and thus the device 100 itself may be ordered and purchased for replacement with a new one. The device 100 may comprise a consumable component 1000, a processor 1003, a memory 1004, a detector 1002, communication circuitry 1005, an input 1006, positioning circuitry 1007, an output 1008, and power supply 1009. The device 100 itself is a replaceable and disposable item with the consumable component 1000 that is part of the device 100. The components may be connected to one another via a bus.

The consumable component 1000 may be subject to regular or irregular use by a user and disposable and replaceable with a new one when the consumable component 1000 has been consumed, exhausted, finished up, or worn.

The detector 1002 may be a circuit, circuitry, module, or other mechanically and/or electronically structured assembly configured to detect information used for determination of exhaustion of the device 100 (i.e., consumable item). The detector 1002 may output a result of the detection to the processor 1003 which may then use the detection result for the determination at the step S30b, S30c, S30f, or S30i. An example of the detector 1002 may include a sensor configured to detect input such as temperature, heat, pressure, acceleration, velocity, humidity, etc. from the external environment, and output the amount of the input as a detection result. The processor 1003 may perform the determination at the steps S30b, S30d, S30f, and S30i on the basis of the detection result. The processor 1003 may determine affirmatively (S30b, S30d, S30f, S30i: Yes) when the detection result is above or below a predetermined threshold. An aspect of the sensor 1002 may be a motion sensor using, for example, an accelerometer and/or gyroscope, configured to detect motion, namely, acceleration or velocity applied to the consumable component 1000. The processor 1003 may count the number of times motions have been cumulatively applied to the consumable component 1000 over time based on the detection result, and determine affirmatively (S30d, S30i: Yes) upon determining that the counted number exceeds a predetermined threshold. Another aspect of the sensor 1002 may be a pressure sensor configured to detect pressure applied to the consumable component 1000. The processor 1003 may count the number of times pressures have been cumulatively applied to the consumable component 1000 over time based on the detection result, and determine affirmatively (S30d, S30i: Yes) upon determining that the counted number exceeds a predetermined threshold. Another aspect of the sensor 1002 may be a level sensor configured to detect the level of the consumable component 1000 when the consumable component 1000 is liquid or fluid stored or contained in a container. Detection of the level below a predetermined threshold may cause the processor 1003 to determine affirmatively (S30d, S30i: Yes) at the steps S30d and S30i. Another example of the detector 1002 may be a timer configured to count time and indicate lapse of time. Indication of lapse of a predetermined time period after start of counting of time may cause the processor 1003 to determine affirmatively (S30d, S30i: Yes) at the steps S30d and S30i. Another example of the detector 1002 may be a clock, in which case indication of time equal to or later than the date represented by the expiration information 108 may cause the processor 1003 to determine affirmatively (S30b, S30f: Yes) at the steps S30b and S30f. The detector 1002 may also be used by the processor 1003 to measure the amount of the consumable item 1001 at the step S211b in response to the inquiry issued at the step S211a.

The processor 1003 may a circuit, circuitry, module or other mechanically and/or electronically structured assembly configured to process various data and to control the components coupled to the processor 1003 based on program instructions. The processor 1003 may be a central processing unit (CPU), a micro processing unit (MPU), a digital signal processor (DSP), a microprocessor, a field programmable gate array (FPGA), another general or dedicated processing unit, or combination thereof.

The memory 1004 may be an electronically and/or mechanically structured assembly configured to store data and programs, which may be a read only memory (ROM), a random access memory (RAM), a hard disk drive (HDD), a solid state drive (SSD), another memorizing component or computer-readable medium or storage in any form, or combination thereof. The memory 1004 may be packaged into an electronic tag such as an integrated circuit (IC) tag and Radio Frequency Identification (RFID) tag. The user ID 101, address 101a, server ID 102, device ID 103, item ID 105, destination information 106, category ID 107, expiration information 108, and determination result 109 may be stored on the memory 1004. The record ID written at the step S210d in the shipment process S200b may be stored as a record ID 120 in the memory 1004. In the embodiments, the item ID 105 may be the identification that identifies the device 100 as the consumable item. The category ID 107 may identify the category to which the device 100 belongs in the database DB1 resident on the server 200. The expiration information 108 may be information indicative of the expiration date until which the device 100 is designed to be usable in a good condition. At the step S20g, the device 100 may store the received device ID on the memory 1004. At the step S22g, the device 100 may store the user ID and address on the memory 1004. At the step S22i, the device 100 may store the destination information on the memory 1004. At the step S23f, the device 100 may store the user ID and address on the memory 1004. At the step S231, the device 100 may store the destination information on the memory 1004. At the steps S101a and S101e, the device 100 may read data (i.e., at least one of the user ID 101, address 101a, item ID 105, destination information 106, category ID 107, and expiration information 108) out of the memory 1004 to issue the request containing the data. At the step S5, the device 100 may update the expiration information 108 on the memory 1004 by overwriting the information 108 with the notified renewed expiration information 208. At the steps S30g and S30i, the device 100 may store the measurement result on the memory 1004. At the step S102a, the device 100 may read the data (i.e., at least one of the user ID 101, address 101a, item ID 105, destination information 106, category ID 107, expiration information 108, and measurement result 109) out of the memory 1004 to send the data to the user's mobile communication device 300. At the step S306b, the user's mobile communication device 300 may read data out of the memory 1004. At the step S212b, the device 100 may read the record ID 120 out of the memory 1004. The memory 1004 may also store a computer program 1041 that includes computer program instructions that, when executed by the processor 1003, cause the processor 1003 to perform the steps on the device 100's part in the processes discussed above.

The communication circuitry 1005 may be circuitry configured to establish the communication 10 with the user's mobile communication device 300 and the communication 11 with the server 200. The communication circuitry 1005 may be a single circuit designed to perform a communication in compliance with a single communication standard, or may be one or more single or combined circuits designed to perform communication in compliance with multiple communication standards.

The input 1006 may be a circuit, circuitry, a module, or other electronically and/or mechanically structured assembly configured to receive a user input made on the input 1006 and feed a signal indicative of the user input to the processor 1003. The input 1006 may include one or more physical keys or buttons. The input 1006 may be a microphone configured to receive voice for input of a voice command by the user. The input 1006 may be used to receive the input at the steps S22b, S22c, and S22h.

The positioning circuitry 1007 may be circuitry configured to determine the current geological position of the device 100 and feed a signal indicative of the determined position to the processor 1003. An example of the positioning circuitry 1007 may include a global positioning system (GPS) circuitry configured to regularly, periodically, repeatedly, or intermittently locate the device 100 based on signals from satellites. Another example of the positioning circuitry 1007 may include a local positioning system (LPS) circuitry configured to regularly, periodically, repeatedly, or intermittently locate the device 100 based on signals from wireless signal transmitters locally installed indoors. The position determined by the positioning circuitry 1007 may be stored as the destination information 106 by the processor 1003. At the step S22h, the device 100 may receive the position determined by the positioning circuitry 1007.

The output 1008 may be a circuit, circuitry, a module, or other electronically and/or mechanically structured assembly configured to output information for presentation visually, acoustically, or in other sensible manners. The output 1008 may be a display configured to display an image for visual presentation. The output 1008 may be a loudspeaker configured to output sound for acoustic notification. The input 1006 and output 1008 may be integrated together to constitute an input/output device such as a touch screen device.

The power supply 1009 may be a circuit, circuitry, a module, or other electronically and/or mechanically structured assembly configured to feed or provide power to the components of the device 100. The power supply 1009 may include a rechargeable battery, a dry cell battery, or other power source that stores and discharges energy. The power supply 1009 may include an AC-DC converter or other component to generate desirable power based on power supplied from a residential or commercial power distribution system via an electrical outlet. The power supply 1009 may include a wireless powered circuit with a coil configured to generate power at the step S102a based on an electric or magnetic waves transmitted by the user's mobile communication device 300 that functions as a NFC or RFID reader at the step S306a. The power supply 1009 may include a wireless powered circuit configured to generate power based on electromagnetic waves wirelessly transmitted by an external wireless powering circuit. The power supply 1009 may include an electrical contact, cable, cord, or wire made of metal or other electrically-conductive materials simply through which power is fed from an outside power source.

All or part of the sensor detector 1002, processor 1003, memory 1004, communication circuitry 1005, input 1006, positioning circuitry 1007, output 1008, and power supply 1009 may be integrated or packaged together in a single chip or a few chips in such a manner as System-On-Chip (SoC), System-In-Package (SiP), and Multi-Chip Module (MCM).

FIG. 17B is a block diagram illustrating an example of the hardware and/or software components of the device 100, according to some embodiments where the consumable item is a refill for the device 100 that is physically separate from the device 100, so that the consumable item may be independently ordered and purchased for replacement with a new one. The device 100 may comprise a container 1011 designed to contain a consumable item 1001, the processor 1003, the memory 1004, the detector 1002, the communication circuitry 1005, the input 1006, the positioning circuitry 1007, the output 1008, and the power supply 1009. The components may be connected to one another via a bus. In the embodiments, the consumable item 1001 may be resident in the container 1011. The container 1011 may be a compartment, chamber, or separate room provided in the housing, preferably as part of the housing, of the device 100. The consumable item 1001 may be a refill, namely, a refillable product that is designed to be inserted into the container 1011, the content of which may be one in a form of liquid, fluid, powder, gas, etc. The detector 1002 may be configured to detect information used for determination of exhaustion of the consumable item 1001. Particularly, the detector 1002 may be a sensor coupled to the container 1011, which is configured to measure the amount of the content of the consumable item 1001 in the container 1011. The sensor 1002 may be a level sensor configured to detect the level of the consumable item 1001 stored in the container 1011. Detection of a level of the consumable item 1001 below a predetermined threshold may cause the processor 1003 to determine affirmatively (S30d, S30i: Yes) at the steps S30d and S30i. The sensor 1002 may be a weight sensor configured to measure the weight of the consumable item 1001 stored in the container 1011. Detection of a weight of the consumable item 1001 below a predetermined threshold may cause the processor 1003 to determine affirmatively (S30d, S30i: Yes) at the steps S30d and S30i. The detector 1002 may be a timer or clock as discussed above. The detector 1002 may be used by the processor 1003 to measure the amount of the consumable item 1001 at the step S211b in response to the inquiry issued at the step S211a. The user ID 101, address 101a, server ID 102, device ID 103, item ID 105, destination information 106, category ID 107, expiration information 108, determination result 109, record ID 120, and computer program 1041 may be stored on the memory 1004. In the embodiments, the item ID 105 may be the identification that identifies the consumable item 1001. The category ID 107 may identify the category to which the consumable item 1001 belongs in the database DB1 resident on the server 200. The expiration information 108 may be information indicative of the expiration date until which the consumable item 1001 is designed to be usable in a good condition. The components 1003, 1004, 1005, 1006, 1007, 1008, and 1009 may function as they do in the implementation shown in FIG. 17A. The device 100 may store data on the memory 1004 and read the data out of the memory 1004, just as it does in the implementation shown in FIG. 17A.

FIG. 17C is a block diagram illustrating another example of the hardware and/or software components of the device 100, according to some embodiments where the consumable item is physically separate from the device 100 and attachable to and detachable or removable from the device 100, so that the consumable item may be independently ordered and purchased for replacement with a new one. The device 100 may comprise an interface 1000a through which the device 100 may communicate with the consumable item 1001. The components may be connected to one another via a bus. In the embodiments, the consumable item 1001 may be one having a case or housing containing the content of the consumable item 1001, which may be in a form of a cartridge. The consumable item 1001 may have an interface 1001a that is connectable with the interface 1000a on the device 100. One of the interfaces 1000a and 1001a may be a male connector while the other one may be a female receptacle, so that the one may be inserted into the other one for them to be connected to one another. The detector 1002 may be a sensor in communication with the consumable item 1001 to measure the amount of the content of the consumable item 1001 when the consumable item 1001 is connected to the device 100 through the interfaces 1000a and 1001a. The sensor 1002 may be a level sensor configured to detect the level of the content of the consumable item 1001. Detection of the level of the content of the consumable item 1001 below a predetermined threshold may cause the processor 1003 to determine affirmatively (S30d, S30i: Yes) at the steps S30d and S30i. The sensor 1002 may be a weight sensor configured to measure the weight of the content of the consumable item 1001. Detection of the weight of the content of the consumable item 1001 below a predetermined threshold may cause the processor 1003 to determine affirmatively (S30d, S30i: Yes) at the steps S30d and S30f. The detector 1002 may be the timer or clock as discussed above. The detector 1002 may be used by the processor 1003 to measure the amount of the content of the consumable item 1001 at the step S211b in response to the inquiry issued at the step S211a. The user ID 101, address 101a, server ID 102, device ID 103, item ID 105, destination information 106, category ID 107, expiration information 108, determination result 109, record ID 120, and computer program 1041 may be stored on the memory 1004. In the embodiments, the item ID 105 may be the identification that identifies the consumable item 1001. The category ID 107 may identify the category to which the consumable item 1001 belongs in the database DB1 resident on the server 200. The expiration information 108 may be information indicative of the expiration date until which the consumable item 1001 is designed to be usable in a good condition. The components 1003, 1004, 1005, 1006, 1007, 1008, and 1009 may function as they do in the implementations shown in FIGS. 17A and 17B. The device 100 may store data on the memory 1004 and read the data out of the memory 1004, just as it does in the implementations shown in FIGS. 17A and 17B.

FIG. 17D is a block diagram illustrating another example of the hardware and/or software components of the device 100, according to some embodiments where modification is made to the example shown in FIG. 17C. In the embodiments, the consumable item 1001 may comprise a memory 1001b. At least one of the item ID 105, category ID 107, expiration information 108, record ID 120, and server ID 102 that are information provided by the seller 3, which is not what is arbitrarily set or generated by the user, may be written and stored on the memory 1001b, instead of being stored on the memory 1004. The remaining ones of the item ID 105, category ID 107, expiration information 108, record ID 108, and server ID 102 may be stored on the memory 1004, as well as the user ID 101, address 101a, destination information 106, device ID 103, determination result 109, and computer program 1041. The detector 1002 and processor 1003 may access to the memory 1001b through the interfaces 1000a and 1001a for retrieval of the data from and writing of the data onto the memory 1001b. At the steps S22g and S23f, the device 100 may store the user ID 101 and address 101a on the memory 1004. At the steps S22i and S23i, the device 100 may store the destination information 106 on the memory 1004. At the steps S101a and S101e, the device 100 may read first data (at least one of the item ID 105, category ID 107, and expiration information 108) out of the memory 1001b via the interfaces 1000a and 1001a, and read second data (at least one of the user ID 101, address 101a, and destination information 106) out of the memory 1004, to issue the request containing the first and second data. At the step S5, the device 100 may update the expiration information 108 on the memory 1001b by overwriting the information 108 with the notified renewed expiration information 208 via the interfaces 1000a and 1001a. At the steps S30g and S30j, the device 100 may store the generated determination result 109 on the memory 1004. At the step S306b, the user's mobile communication device 300 may read first data (at least one of the item ID 105, category ID 107, and expiration information 108) out of the memory 1001b, and read second data (at least one of the user ID 101, address 101a, destination information 106, and determination result 109) out of the memory 1004. At the step S212b, the device 100 may read the record ID 120 out of the memory 1001b via the interfaces 1000a and 1001a. The components 1003, 1004, 1005, 1006, 1007, 1008, and 1009 may function as they do in the system discussed above in FIGS. 17A, 17B, and 17C.

FIG. 17E is a block diagram illustrating another example of the hardware and/or software components of the device 100, according to some embodiments where the consumable item is physically separate from the device 100 and is designed to be stored or preserved in the device 100, so that the consumable item may be independently ordered and purchased for replacement with a new one. The device 100 may comprise a compartment 1012, the processor 1003, the memory 1004, the detector 1002, the communication circuitry 1005, the input 1006, the positioning circuitry 1007, the output 1008, and the power supply 1009. The components may be connected to one another via a bus. The compartment 1012 may be part of the housing of the device 100 or a space provided in the housing, in which the consumable item 1001 may be situated for storage. In the embodiments, the consumable item 1001 may include a NFC or RFID tag 1001c on which at least one of the item ID 105, category ID 107, expiration information 108, record ID 120, and server ID 102 is stored that are information provided by the seller 3. The communication circuitry 1005 may include a NFC or RFID antenna through which to radiate electromagnetic waves when the device 100 is activated as a NFC or RFID reader, to provide electromagnetic induction based on which the tag 1001c is powered and activated to send the stored data to the device 100. As a result, a NFC or RFID communication is established between the device 100 and the consumable item 1001, so that the device 100 may retrieve the data stored on the tag 1001c over the NFC or RFID communication. The detector 1002 may be a sensor in communication with the consumable item 1001 over the NFC or RFID communication to retrieve the stored data based on which the processor 103 may perform the determination at the steps S30d and S30i. The detector 1002 may be a clock, in which case the processor 1003 may compare the current date indicated by the clock 1002 with the expiration date represented by the expiration information 108 retrieved from the tag 1001c over the NFC or RFID communication, and determine affirmatively (S30b, S30f: Yes) upon the current date being equal to or later than the expiration date at the steps S30b and 30f. The detector 1002 may be a sensor configured to measure the amount of the content of the consumable item 1001 over the NFC or RFID communication. The sensor 1002 may be a level sensor configured to detect the level of the content of the consumable item 1001. Detection of the level of the content of the consumable item 1001 below a predetermined threshold may cause the processor 1003 to determine affirmatively (S30d, S30i: Yes) at the steps S30d and S30i. The detector 1002 may be used by the processor 1003 to measure the amount of the content of the consumable item 1001 at the step S211b in response to the inquiry issued at the step S211a. In the embodiments, at least one of the item ID 105, category ID 107, expiration information 108, record ID 120, and server ID 102 that are information provided by the seller 3, which is not what is arbitrarily set or generated by the user, may be written and stored on the tag 1001c, instead of being stored on the memory 1004. The remaining ones of the item ID 105, category ID 107, expiration information 108, record ID 108, and server ID 102 may be stored on the memory 1004, as well as the user ID 101, address 101a, destination information 106, device ID 103, determination result 109, and computer program 1041. The item ID 105 may be the identification that identifies the consumable item 1001. The category ID 107 may identify the category to which the consumable item 1001 belongs in the database DB1 resident on the server 200. The expiration information 108 may be information indicative of the expiration date until which the consumable item 1001 is designed to be usable in a good condition. At the steps S22g and S23f, the device 100 may store the user ID 101 and address 101a on the memory 1004. At the steps S22i and S23i, the device 100 may store the destination information 106 on the memory 1004. At the step S101a, the device 100 may read first data (at least one of the item ID 105, category ID 107, and expiration information 108) out of the tag 1001c over the NFC or RFID communication, and read second data (at least one of the user ID 101, address 101a, and destination information 106) out of the memory 1004, to issue the request containing the first and second data. At the step S5, the device 100 may update the expiration information 108 on the tag 1001c by overwriting the information 108 with the notified renewed expiration information 208 over the NFC or RFID communication. At the steps S30g and S30j, the device 100 may store the generated determination result 109 on the memory 1004. At the step S306b, the user's mobile communication device 300 may read first data (at least one of the item ID 105, category ID 107, and expiration information 108) out of the tag 1001c, and read second data (at least one of the user ID 101, address 101a, destination information 106, and determination result 109) out of the memory 1004. At the step S212b, the device 100 may read the record ID 120 out of the tag 1001c over the NFC or RFID communication. The components 1003, 1004, 1005, 1006, 1007, 1008, and 1009 may function as they do in the implementations shown in FIGS. 17A, 17B, 17C, and 17D.

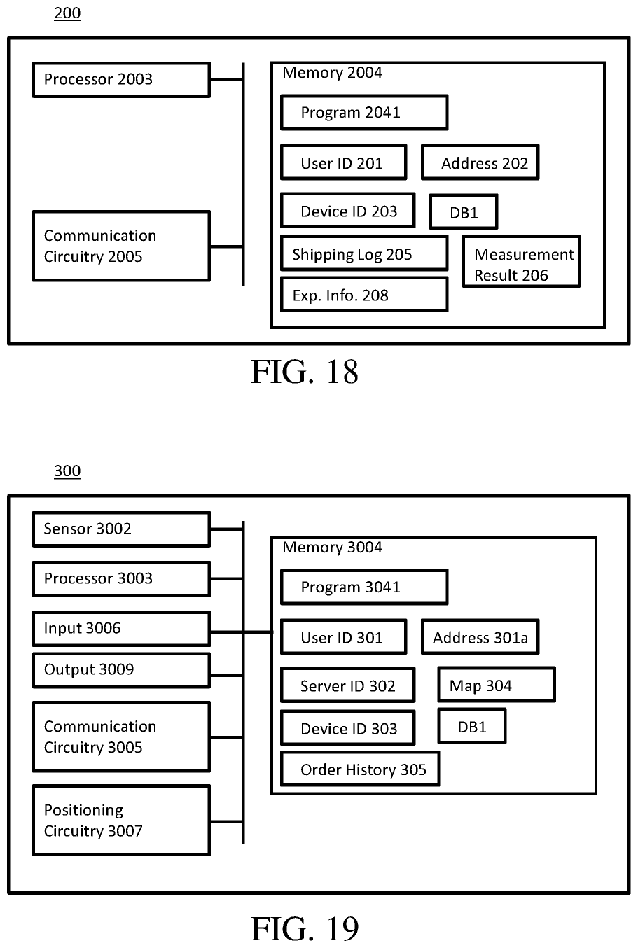

FIG. 18 is a block diagram illustrating an example of the hardware and/or software components of the server 200, according to some embodiments. The server 200 may comprise a processor 2003, a memory 2004, and communication circuitry 2005. The components may be connected to one another via a bus. The server 200 may be implemented by a personal computer (PC), workstation, or other general or specially designed powerful computer. The server 200 may be implemented by a single computer or a combination of multiple computers.

The processor 2003 may be a circuit, circuitry, module or other mechanically and/or electronically structured assembly configured to process various data and to control the components coupled to the processor 2003 based on program instructions. The processor 2003 may be a CPU, an MPU, a DSP, a microprocessor, a FPGA, another general or dedicated processing unit, or combination thereof.

The memory 2004 may be an electronically and/or mechanically structured assembly configured to store data and programs, which may be a ROM, a RAM, an HDD, an SSD, another memorizing component or computer-readable medium or storage in any form, or combination thereof. The memory 2004 may be packaged into an electronic tag such as an IC tag and RFID tag. The user IDs 201, associated addresses 202, database DB1, device ID 203, shipping log 205, expiration information 208, and a measurement record 206 may be stored on the memory 2004. The measurement record 206 may be the record of the results of the measurement generated according to the step S211d, such as one illustrated in FIG. 14B or 14C. The memory 2004 may also store a computer program 2041 that includes computer program instructions that, when executed by the processor 2003, cause the processor 2003 to perform the steps on the server 200's part in the processes discussed above.

The communication circuitry 2005 may be circuitry configured to establish the communication 11 with the device 100 and the communication 12 with the user's mobile communication device 300. The communication circuitry 2005 may also be configured to establish the communication 14 with the printer 400. The communication circuitry 2005 may also be configured to establish the communication 15 with the terminal 500. The communication circuitry 2005 may be a single circuit designed to perform a communication in compliance with a single communication standard, or may be one or more single or combined circuits designed to perform communication in compliance with multiple communication standards.

FIG. 19 is a block diagram illustrating an example of the hardware and/or software components of the user's mobile communication device 300, according to some embodiments. The user's mobile communication device 300 may comprise an image sensor 3002, a processor 3003, a memory 3004, communication circuitry 3005, an input 3006, positioning circuitry 3007, and an output 3008. The components may be connected to one another via a bus. The user's mobile communication device 300 may be implemented by a smartphone, tablet, laptop, or other portable or handheld computing device.

The image sensor 3002 may be a circuit, circuitry, module, or other mechanically and/or electronically structured assembly configured to capture image to feed corresponding image data to the processor 3003, so that the processor 3003 can process the image data. The image sensor 3002 may be implemented by a camera, scanner, etc. The image sensor 3002 may be used to capture a barcode at the step S24e, so that the encoded data is decoded by the processor 3003 at the step S24f.

The processor 3003 may a circuit, circuitry, module or other mechanically and/or electronically structured assembly configured to process various data and to control the components coupled to the processor 3003 based on program instructions. The processor 3003 may be a CPU, a MPU, a DSP, a microprocessor, a FPGA, another general or dedicated processing unit, or combination thereof.

The memory 3004 may be an electronically and/or mechanically structured assembly configured to store data and programs, which may be a ROM, a RAM, a HDD, a SSD, another memorizing component or computer-readable medium or storage in any form, or combination thereof. The user ID 301, address 301a, server ID 302, device ID 303, map 304, database DB1, and order history 305 may be stored on the memory 3004. The memory 3004 may also store a computer program 3041 that includes computer program instructions that, when executed by the processor 3003, cause the processor 3003 to perform the steps on the device 300's part in the processes discussed above.

The communication circuitry 3005 may be circuitry configured to establish the communication 10 with the device 100 and the communication 12 with the server 200. The communication circuitry 1005 may be a single circuit designed to perform a communication in compliance with a single communication standard, or may be one or more single or combined circuits designed to perform communication in compliance with multiple communication standards. The communication circuitry 3005 may include a NFC or RFID antenna that through which to radiate electromagnetic waves when the device 300 is activated as a NFC or RFID reader at the step S306a, to provide electromagnetic induction based on which the device 100 is powered at the step S102a. The NFC or RFID antenna may also be used when the device 300 is activated as a NFC or RFID reader at the step S24a to retrieve data by reading the tag 110 at the step S24b.

The input 3006 may be a circuit, circuitry, a module, or other electronically and/or mechanically structured assembly configured to receive a user input made on the input 3006 and feed a signal indicative of the user input to the processor 3003. The input 3006 may include one or more physical keys or buttons. The input 3006 may be a microphone configured to receive voice for input of a voice command by the user. The input 3006 may be used to receive the input at the steps S21b, S21c, S23c, S23d, S23j, S300b, S300e, S3050b, S3050e, and S306d.

The positioning circuitry 3007 may be circuitry configured to determine the current geological position of the device 300 and feed or provide a signal indicative of the determined position to the processor 3003. An example of the positioning circuitry 3007 may include a GPS circuitry configured to regularly, periodically, repeatedly, or intermittently locate the device 300 based on signals from satellites. Another example of the positioning circuitry 3007 may include a LPS circuitry configured to regularly, periodically, repeatedly, or intermittently locate the device 300 based on signals from wireless signal transmitters locally installed indoors. The position determined by the positioning circuitry 3007 may be sent to the device 100 at the step S23k.

The output 3008 may be a circuit, circuitry, a module, or other electronically and/or mechanically structured assembly configured to output information for presentation visually, acoustically, or in other sensible manners. The output 3008 may be a display configured to display an image for visual presentation. The output 3008 may be a loudspeaker configured to output sound for acoustic notification. The input 3006 and output 3008 may be integrated together to constitute an input/output device such as a touch screen device. The output 3008 may provide the UI at the steps S300, S305b, and S306d.

### Example of Device 100

The device 100 may be a disposable toothbrush that is the consumable item itself. The toothbrush 100 may comprise a bundle of bristles, as the consumable component 1000, that are exhausted as the user's teeth are scrubbed with the bristles. The detector 1002 may be a timer configured to count time, so that the processor 1003 determines exhaustion of the bristles 1000 upon the counted time being equal to or above a predetermined time period (e.g., 2,160 hours or 90 days) because it is likely that user's continuous use of the toothbrush 100 for the time period may cause the bristles 1000 to be worn out so much that the toothbrush should be replaced with a new one. The item ID 105 may identify the device 100 (toothbrush 100) itself. The category ID 107 may identify the category “toothbrush” to which the device 100 belongs.

The device 100 may be a toothbrush including a replaceable brush head, as the consumable item 1001, that comprises a bundle of bristles. The replacement brush head 1001 is attachable to and detachable from the toothbrush 100 for replacement. The toothbrush 100 may be an electric toothbrush that is provided with a built-in motor configured to reciprocate or rotate the brush head 1001 for brushing operation. The detector 1002 may be a timer, so that the processor 1003 counts time for which power is supplied to the motor by the power supply 1009 to determine exhaustion of the replacement head 1001 upon the counted time exceeding a predetermined threshold, because it is likely that user's continuous use of the toothbrush 100 for a long time may cause the bristles of the brush head 1001 to be worn out so much that the brush head 1001 should be replaced with a new one. The detector 1002 may be a pressure sensor configured to detect pressure applied to the brush head 1001, so that the processor 1003 counts time for which pressure to the brush head 1001 is detected to determine exhaustion of the replacement brush head 1001 upon the counted time exceeding a predetermined time threshold, because it is likely that user's use of the toothbrush 100 may be represented by application of pressure to the brush head 1001 for brushing. The item ID 105 may identify the toothbrush replacement brush head 1001. The category ID 107 may identify the category “toothbrush replacement brush head” to which the replacement brush head 1001 belongs. The restriction of use of the toothbrush 100 at the steps S211h and S212f may include the server 200 sending a command that instructs the toothbrush 100 to deactivate the brushing operation, in response to which the toothbrush 100 may cut off power supply to the motor from the power supply 1009 to restrict the motor from operating for brushing. Similarly, the voluntary restriction of use of the toothbrush 100 at the step S213c may include the toothbrush 100 voluntarily cutting off power supply to the motor from the power supply 1009.

The device 100 may be a disposable pen that is the consumable item itself. The pen 100 may comprise an ink reservoir in which ink, as the consumable component 1000, is filled. The pen 100 consumes ink 1000 in the ink reservoir to operate as a pen. The detector 1002 may be a sensor configured to measure the amount of the ink 1000 left in the ink reservoir, so that the processor 1003 determines exhaustion of the ink 1000 upon the measured amount of the ink 1000 being below a predetermined threshold. The item ID 105 may identify the device 100 (pen 100) itself. The category ID 107 may identify the category “pen” to which the device 100 belongs.

The device 100 may be a pen including a replaceable ink cartridge in which ink is filled, as the consumable item 1001. The ink cartridge 1001 is attachable to and detachable from the pen 100 for replacement. The pen 100 may consume ink in the ink cartridge 1001 to operate as a pen. The detector 1002 may be a sensor configured to measure the amount of ink left in the ink cartridge 1001, so that the processor 1003 determines exhaustion of the ink cartridge 1001 upon the measured amount of the ink being below a predetermined threshold. The item ID 105 may identify the ink cartridge 1001. The category ID 107 may identify the category “ink cartridge for pens” to which the ink cartridge 1001 belongs.

The device 100 may be a disposable razor that is the consumable item itself. The razor 100 may comprise one or more blades for shaving, as the consumable component 1000. The detector 1002 may be a timer configured to count time, so that the processor 1003 determines exhaustion of the blades 1000 upon the counted time being equal to or above a predetermined time period because it is likely that user's continuous use of the razor 100 for the time period may cause the blades 1000 to be worn out so much that the razor should be replaced with a new one. The item ID 105 may identify the device 100 (razor 100) itself. The category ID 107 may identify the category “disposable razor” to which the device 100 belongs.

The device 100 may be a shaver including a replaceable shaver head, as the consumable item 1001, coupled to the body or handle of the shaver. The shaver head 1001 may include one or more blades for shaving. The shaver head 1001 is attachable to and detachable from the shaver 100 for replacement. The shaver 100 may be an electric shaver that is provided with a built-in motor configured to reciprocate or rotate the shaver head 1001 for shaving operation. The detector 1002 may be a timer, so that the processor 1003 counts time for which power is supplied to the motor by the power supply 1009 to determine exhaustion of the replacement shaver head 1001 upon the counted time exceeding a predetermined threshold. The item ID 105 may identify the replacement shaver head 1001. The category ID 107 may identify the category “replacement shaver head” to which the consumable item 1001 belongs. The restriction of use of the shaver 100 at the steps S211h and S212f may include the server 200 sending a command that instructs the shaver 100 to deactivate the shaving operation, in response to which the shaver 100 may cut off power supply to the motor from the power supply 1009 to restrict the motor from operating for shaving. Similarly, the voluntary restriction of use of the shaver 100 at the step S213c may include the shaver 100 voluntarily cutting off power supply to the motor from the power supply 1009.

The device 100 may be an electric lamp or light bulb that is the consumable item itself. The lamp 100 may be designed to be held by a light fixture or light fitting, and may be attached to and detached from the light fixture for easy replacement. The lamp 100 may be an incandescent lamp, a fluorescent lamp, a light-emitting diode (LED) lamp, etc. depending on the technology on which the lamp 100 relies for producing light. The lamp 100 may comprise one or more electrodes or filaments, as the consumable component 1000, that are electrified to produce light, or may comprise a LED chip as the consumable component 1000 that is fed power to produce light. The detector 1002 may detect that the filament, electrode, or LED chip 1000 has been worn out or is about to be worn out. The detector 1002 may be a timer, so that the processor 1003 counts time for which power is supplied to the filament, electrode, or LED chip 1000 by the power supply 1009 to determine exhaustion of the filament, electrode, or LED 1000 upon the counted time exceeding a predetermined threshold. The detector 1002 may be a sensor configured to measure the voltage between two ends of respective two electrodes, so that the processor 1003 determines exhaustion of the electrodes 1000 based on the measured voltage. The detector 1002 may be a light sensor or photodetector configured to detect ambient light, so that the processor 1003 determines exhaustion of the filament, electrode, or LED chip 1000 upon the light level or intensity of the detected ambient light being below a predetermined threshold, because it is likely that the intensity of light weakens as the filament, electrode, or LED chip 1000 gets worn out. The item ID 105 may identify the device 100 (lamp 100) itself. The category ID 107 may identify the category “lamp”, or more specifically “incandescent lamp”, “fluorescent lamp”, or “LED lamp” to which the device 100 belongs.

The device 100 may be a light fixture or light fitting designed to receive and hold a replaceable lamp or light bulb, in which case the replaceable lamp is the consumable item 1001. The lamp 1001 is attachable to and detachable from the light fixture 100 for replacement. The light fixture 100 may supply power to the connected lamp 1001 through the power supply 1009 so as for the map 1001 to produce light. The lamp 1001 may be an incandescent lamp, a fluorescent lamp, a LED lamp, etc. depending on the technology on which the lamp 1001 relies for producing light. The lamp 1001 may comprise one or more electrodes or filaments that are electrified to produce light, or may comprise a LED chip that is fed power to produce light. The detector 1002 may detect that the filament, electrode, or LED chip in the lamp 1001 has been worn out or is about to be worn out. The detector 1002 may be a timer, so that the processor 1003 counts time for which power is supplied to the lamp 1001 by the power supply 1009 to determine exhaustion of the lamp 1001 upon the counted time exceeding a predetermined threshold. The detector 1002 may be a sensor configured to measure the voltage between two ends of respective two electrodes in the lamp 1001, so that the processor 1003 determines exhaustion of the lamp 1001 based on the measured voltage. The detector 1002 may be a light sensor or photodetector configured to detect ambient light, so that the processor 1003 determines exhaustion of the lamp 1001 upon the light level or intensity of the detected ambient light being below a predetermined threshold, because it is likely that the intensity of light weakens as the filament, electrode, or LED chip in the lamp 1001 gets worn out. The item ID 105 may identify the device 100 (light fixture 100) itself. The category ID 107 may identify the category “lamp”, or more specifically “incandescent lamp”, “fluorescent lamp”, or “LED lamp” to which the consumable item 1001 belongs. The restriction of use of the light fixture 100 at the steps S211h and S212f may include the server 200 sending a command that instructs the light fixture 100 to stop lighting operation, in response to which the light fixture 100 may cut off power supply from the power supply 1009 to the connected lamp 1001 to prevent the lamp 1001 from producing light. Similarly, the voluntary restriction of use of the light fixture 100 at the step S213c may include the light fixture 100 voluntarily cutting off power supply from the power supply 1009 to the connected lamp 1001.

The device 100 may be a xerography machine, such as a photocopier, printer, multi-functional printer (MFP), etc., including a replaceable toner cartridge, as the consumable item 1001, in which toner is filled. The xerography machine 100 may operate as a photocopier to copy text and visual images on paper using the toner in the toner cartridge 1001 by xerography. The xerography machine 100 may operate as a printer to copy text and visual images generated and fed by a computer using the toner in the toner cartridge 1001 by xerography. The toner cartridge 1001 is attachable to and detachable from the xerography machine 100 for replacement. The xerography machine 100 may be provided with a xerography assembly including components configured to perform the typical steps of the xerography process: charging, exposure, development, transfer, and fusing. The detector 1002 may be a sensor configured to measure the amount of the toner in the toner cartridge 1001, so that the processor 1003 determines exhaustion of the toner cartridge 1001 upon the measured amount being below a predetermined threshold. The item ID 105 may identify the toner cartridge 1001. The category ID 107 may identify the category “toner cartridge for xerography machine” to which the toner cartridge 1001 belongs. The restriction of use of the xerography machine 100 at the steps S211h and S212f may include the server 200 sending a command that instructs the xerography machine 100 to stop the xerography operation, in response to which the xerography machine 100 may deactivate the xerography assembly to restrict performance of the xerography process. Similarly, the voluntary restriction of use of the xerography machine 100 at the step S213c may include the xerography machine 100 voluntarily deactivating the xerography assembly by, for example, cutting off power supply from the power supply 1009 to the xerography assembly.

The device 100 may be an inkjet machine, such as an inkjet copier and inkjet printer, including a replaceable ink cartridge, as the consumable item 1001, in which ink is filled. The inkjet machine 100 may operate as a copier to copy text and visual images on paper using the ink in the ink cartridge 1001 by inkjet printing. The inkjet machine 100 may operate as a printer to copy text and visual images generated and fed by a computer using the ink in the ink cartridge 1001 by inkjet printing. The ink cartridge 1001 is attachable to and detachable from the inkjet machine 100 for replacement. The inkjet machine 100 may be provided with an inkjet assembly including components configured to perform the inkjet printing process, such as a nozzle through which to eject droplets of the ink onto paper. The detector 1002 may be a sensor configured to measure the amount of the ink in the ink cartridge 1001, so that the processor 1003 determines exhaustion of the ink cartridge 1001 upon the measured amount being below a predetermined threshold. The item ID 105 may identify the ink cartridge 1001. The category ID 107 may identify the category “ink cartridge for inkjet machine” to which the ink cartridge 1001 belongs. The restriction of use of the inkjet machine 100 at the steps S211h and S212f may include the server 200 sending a command that instructs the inkjet machine 100 to stop the inkjet printing, in response to which the inkjet machine 100 may deactivate the inkjet assembly to restrict performance of the inkjet printing process. Similarly, the voluntary restriction of use of the inkjet machine 100 at the step S213c may include the inkjet machine 100 voluntarily deactivating the inkjet assembly by, for example, cutting off power supply from the power supply 1009 to the inkjet assembly.

The device 100 may be a washing machine for washing of dishes, clothes, etc. including a container or reservoir in which detergent, as the consumable item 1001, is filled. The washing machine 100 may operate to wash a target object such as dishes, clothes, etc. using the detergent 1001 in the reservoir. The washing machine 100 may be provided with a washing assembly including components configured to perform the washing process. The components may include a tub or drum in which the target object is situated coupled to a motor configured to rotate the tub, an agitator in the tub, a pump configured to supply water mixed with the detergent 1001 into the tub, a dryer configured to supply warm wind into the tub to dry the target object after it's washed, etc. The detector 1002 may be a sensor configured to measure the amount of the detergent 1001 in the reservoir, so that the processor 1003 determines exhaustion of the detergent 1001 upon the measured amount being below a predetermined threshold. The item ID 105 may identify the detergent 1001. The category ID 107 may identify the category “detergent” to which the consumable item 1001 belongs. The restriction of use of the washing machine 100 at the steps S211h and S212f may include the server 200 sending a command that instructs the washing machine 100 to stop the washing, in response to which the washing machine 100 may deactivate the washing assembly to restrict performance of the washing process. Similarly, the voluntary restriction of use of the washing machine 100 at the step S213c may include the washing machine 100 voluntarily deactivating the washing assembly by, for example, cutting off power supply from the power supply 1009 to the washing assembly.

The device 100 may be a battery-powered device, such as a remote, clock, digital picture frame, radio-controlled (R/C) toy, and other electronic devices or gadgets. The device 100 includes a battery compartment in which one or more dry cells, as the consumable item 1001, are situated. The device 100 is powered by the dry cell 1001 to operate battery-powered components inside the device 100. The detector 1002 may be a sensor configured to measure the battery level of the dry cell 1001, so that the processor 1003 determines exhaustion of the dry cell 1001 upon the measured battery level being below a predetermined threshold. The item ID 105 may identify the dry cell 1001. The category ID 107 may identify the category “dry cell” to which the consumable item 1001 belongs. The restriction of use of the battery-powered device 100 at the steps S211h and S212f may include the server 200 sending a command that instructs the device 100 to stop the battery-powered operation, in response to which the device 100 may deactivate the battery-powered components to restrict performance of the operation Similarly, the voluntary restriction of use of the device 100 at the step S213c may include the device 100 voluntarily deactivating the battery-powered components by, for example, cutting off power supply from the dry cell 1001 to the battery-powered components.

The device 100 may be a storage or reservoir for storage or preservation of a specific consumable item 1001 such as food items, etc. For the food items, the device 100 may be a refrigerator, fridge, or freezer including the compartment 1012 in which the food items can be situated. Each consumable item 1001 to be stored in the storage 100 may include the tag 1001c on which the expiration information (best-before date information) 108 is stored. The device 100 may periodically activate the communication circuitry 1005 to operate as a NFC or RFID reader in order to power and activate each tag 1001c for retrieval of the expiration information 108 from the each tag 1001c. The detector 1002 may be a clock, so that the processor 1003 may determine that the consumable item 1001 should be replaced with a new one (S30b, S30f: Yes) in response to the clocked date being later than the expiration date (e.g., best-before date for the food item) identified by the retrieved expiration information 108. The determination may be performed for every consumable item 1001 in the compartment 1012. For the food item, the category ID 107 may identify the category, such as “milk”, “egg”, etc. to which the food item 1001 belongs. The storage 100 may be provided with a door or other means for access to the consumable items 1001 in the compartment 1012, and a locking mechanism for locking and unlocking the door. The restriction of use of the storage 100 at the steps S211h and S212f may include the server 200 sending a command that instructs the storage 100 to deactivate the storage functionality, in response to which the storage 100 may lock the door using the locking mechanism to prevent access to the consumable items 1001 in the compartment 1012. Similarly, the voluntary restriction of use of the storage 100 at the step S213c may include the storage 100 voluntarily locking the door using the locking mechanism. In case of the refrigerator, fridge, or freezer, the storage 100 may be provided with a cooling or refrigeration mechanism including a compressor, evaporator, and condenser to refrigerate or freeze the food items 1001 in the compartment 1012. The restriction of use of the storage 100 at the steps S211h and S212f may include the server 200 sending a command that instructs the storage 100 to deactivate the storage functionality, in response to which the storage 100 may deactivate the refrigeration mechanism by, for example, cutting off power supply from the power supply 1009 to the refrigeration mechanism. Similarly, the voluntary restriction of use of the storage 100 at the step S213c may include the storage 100 voluntarily deactivating the refrigeration mechanism.

### CONCLUSION

Thanks to the embodiments discussed above, when a consumable item is determined to be consumed, exhausted, or worn out, an order for purchase of a new one of the consumable item or an alternative consumable item may be automatically sent to a seller of the consumable item, and/or may be automatically proposed to a user of the consumable item, using information technologies. The automatic order and proposal may help user's constant purchases of the consumable item from the seller without the need of going out for shopping or accessing to online stores for online shopping, accordingly helping the seller's constant sales of the consumable item as well. The presentation of the destination information associated with an ordered and delivered consumable item to the user may help the user's replacement of the exhausted consumable item with the newly delivered consumable item by letting him/her know where the exhausted consumable item is in his/her place at which the delivered new item has arrived. The restriction of use of a device associated with the consumable item may further strengthen relationship or commitment between the user and seller, accordingly ensuring more the user's constant purchases of the consumable items from the seller. The embodiments discussed above have more various practical advantages as technical solutions for particular technical problems as discussed above.

Further modifications and alternative embodiments will be apparent to those skilled in the art in view of this disclosure. Accordingly, the above description is to be construed as illustrative only and is for the purpose of teaching those skilled in the art the manner of carrying out the invention. It is to be understood that the forms of the invention herein shown and described are to be taken as exemplary embodiments. Various modifications may be made without departing from the scope of the invention. For example, equivalent elements or materials may be substitute for those illustrated and described herein, and certain features of the invention may be utilized independently of the use of other features, all as would be apparent to one skilled in the art after having the benefit of this description of the invention. In addition, the terms “a” and “an” are generally used in the present disclosure to mean one or more.

What is claimed is:

1. A method, comprising:
determining, by a user device associated with a consumable item, whether or not the consumable item has been consumed, exhausted, expired, or otherwise needs to be replaced with a new one, using a sensor provided in the user device;
upon determining affirmatively that the consumable item has been consumed, exhausted, expired, or otherwise needs to be replaced with a new one, generating, by the user device, a shipment request associated with the consumable item with or without a user intervention;
issuing, by the user device, the generated shipment request to a seller's server computer over a wide area network (WAN) communication, wherein the seller's server computer is connected on the WAN under control of a seller of the consumable item;
in response to receipt of the shipment request, identifying, by the seller's server computer, a shipment item that is one of (a) a new one of the consumable item identified by a first item identifier assigned to the consumable item and (b) an alternative item identified by a second item identifier distinct from the first item identifier but belonging to the same product category as the consumable item;
identifying, by the seller's server computer, a shipment address to which the identified shipment item is to be shipped; and
executing, by the seller's server computer, a shipment process for shipment of the identified shipment item to the identified shipment address.
